(19) United States
(12) Patent Application Publication
(10) Pub. No.: US 2026/0089100 A1
(43) Pub. Date: Mar. 26, 2026

(54) NON-DISRUPTIVE FASTPATH FLOW INVALIDATION SCHEME TO ADDRESS NETWORKING CONFIGURATION CHANGES

(71) Applicant: Oracle International Corporation, Redwood Shores, CA (US)

(72) Inventors: Leonard Thomas Tracy, Bothell, WA (US); Anantha Ramaiah, San Jose, CA (US); Wei Qian, Seattle, WA (US)

(73) Assignee: Oracle International Corporation, Redwood Shores, CA (US)

(21) Appl. No.: 18/896,540

(22) Filed: Sep. 25, 2024

(51) Int. Cl. H04L 45/76; H04L 43/12; H04L 45/121

(52) U.S. Cl. CPC H04L 45/76; H04L 43/12; H04L 45/121

(57) ABSTRACT

Improved network traffic flow processing techniques are described. In a network device providing multiple processing planes, different processing resources can be allocated to affect efficient and rapid packet processing. This allocation of resources can be upset via receipt of a configuration update. When a configuration update is received, a previously programmed flow can be provisionally invalidated. To prevent the overwhelming of slow path resources, a provisionally invalid flow can continue to be processed according to previous programming by a fast path.

### BACKGROUND

In today's distributed computing environment there is a constant need to enable faster data communications. This is especially true for a cloud service provider (CSP) providing cloud services to subscribing customers. Faster data communications translate to faster delivery of the cloud services to users of the cloud services, which in turn translates to better customer and user experience. There is thus a constant desire to improve the infrastructure provided by the CSP for provisioning cloud services.

A network traffic flow (also referred to as a “network flow” or “traffic flow” or just “flow”) typically identifies packets communicated between two specific endpoints. How fast data can be communicated from a source to a destination depends upon various criteria including the path taken by the packets from the source to the destination and how fast the network devices in that path can process flows of data packets. There is always a need for improvements in the architectures of network devices and the techniques they use for processing packet flows to enable even faster data communications.

### BRIEF SUMMARY

Techniques are provided (e.g., a method, a system, non-transitory computer-readable medium storing code or instructions executable by one or more processors) herein for non-disruptive fastpath flow invalidation scheme to address networking configuration changes. One aspect of the method relates to receiving a packet of a flow for fast path processing according to initial fast path programming at fast path hardware of a Network Virtualization Device (“NVD”), determining with the fast path that the flow and the initial fast path programming are provisionally invalid, and processing the packet according to the initial fast path programming with the fast path hardware.

In some embodiments, the method includes receiving a configuration update before receiving the packet. In some embodiments, the configuration update is received by a control plane. In some embodiments, the control plane is part of a slow path. In some embodiments, the method includes designating the initial flow as provisionally invalid with the control plane. In some embodiments, designating the initial flow a provisionally invalid can include providing an epoch bump to the fast path. In some embodiments, determining with the fast path that the flow and the initial fast path programming are provisionally invalid is based on a comparison of an epoch associated with the initial fast path programming and the received epoch bump.

In some embodiments, the method further includes generating a probe packet at the fast path, and sending the probe packet from the fast path. In some embodiments, generating the probe packet can include replicating at least portions of the received packet. In some embodiments, the at least portions of the received packet can include the header of the received packet. In some embodiments, the probe packet can be generated when the fast path determines that a probe packet was not previously generated for the flow of the received packet. In some embodiments, the probe packet is generated when the fast path determines that a probe packet was not previously generated for the flow of the received packet within a predetermined timeframe.

In some embodiments, the method includes processing the probe packet at a slow path. In some embodiments, processing the probe packet at the slow path can include reprogramming the fast path to process packets based on the configuration update. In some embodiments, the programming of the fast path identifies at least one of a set of rules for: decapsulating a received packet, encapsulating a received packet, and/or routing a received packet.

In some embodiments, the flow remains provisionally invalid until the earlier of passing of a predetermined amount of time, or reprogramming of the fast path. In some embodiments, the flow is invalidated when the fast path is not reprogrammed within a predetermined amount of time. In some embodiments, the method includes receiving a second packet of the flow subsequent to receipt of the packet and after the passing of the predetermined amount of time, determining with the fast path that the flow and the initial fast path programming are invalid, and dropping the second packet.

One aspect relates to a system. The system can include memory including processor-executable stored instructions, and a processor. The processor can execute the stored instructions to receive a packet of a flow for fast path processing according to initial fast path programming at fast path hardware of a Network Virtualization Device (“NVD”), determine with the fast path that the flow and the initial fast path programming are provisionally invalid, and process the packet according to the initial fast path programming with the fast path hardware.

One aspect relates to a non-transitory computer-readable storage medium storing a plurality of instructions executable by one or more processors. When the plurality of instructions are executed by the one or more processors, the plurality of instructions cause the one or more processors to receive a packet of a flow for fast path processing according to initial fast path programming at fast path hardware of a Network Virtualization Device (“NVD”), determine with the fast path that the flow and the initial fast path programming are provisionally invalid, and process the packet according to the initial fast path programming with the fast path hardware.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a high-level diagram of a distributed environment showing a virtual or overlay cloud network hosted by a cloud service provider infrastructure according to certain embodiments.

FIG. 2 depicts a simplified architectural diagram of the physical components in the physical network within a cloud services provider infrastructure (CSPI) according to certain embodiments.

FIG. 3 shows an example arrangement within CSPI where a host machine is connected to multiple network virtualization devices (NVDs) according to certain embodiments.

FIG. 4 depicts connectivity between a host machine and an NVD for providing I/O virtualization for supporting multitenancy according to certain embodiments.

FIG. 5 depicts a simplified block diagram of a physical network provided by a CSPI according to certain embodiments.

FIG. 6 is a simplified block diagram of an example network device (e.g., a network virtualization device (NVD)) that may implement one or more of the innovative techniques described in this disclosure.

FIG. 7 depicts a simplified flowchart showing processing performed by an NVD (or a network device, in general) upon receiving a packet for a new flow according to certain embodiments.

FIG. 8 is a schematic depiction of an embodiment of provisional invalidation.

FIG. 9 is a flowchart depicting one embodiment of a process for provisional invalidation.

FIG. 10 is a flowchart illustrating one embodiment of a process for control plane actions for provisional invalidation.

FIG. 11 is a block diagram illustrating one pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates to improved network traffic flow processing techniques and/or flow management techniques. More specifically, in a network device that includes at least two different processing planes for processing packets, improved techniques are disclosed that take advantage of network flow affinity or locality for faster processing related to network traffic flows. In a network device providing multiple processing planes, each processing plane comprising multiple processing units, techniques described herein take advantage of flow affinity or locality such that the same processing component of a processing plane, which previously performed processing for a network flow, is used for performing subsequent processing for the same network flow. This enables faster processing of network traffic flows by the network device. In certain implementations, the techniques described herein can be implemented in a network virtualization device (NVD) that is configured to perform network virtualization functions.

In some NVD implementations, a single processing plane is provided comprising multiple processing units such as cores (e.g., ARM Cores). When such an NVD receives a packet belonging to a network flow, the packet is forwarded to a particular core from the multiple cores of the NVD. The particular core then performs a function (e.g., encapsulate the packet, decapsulate the packet, etc.) and the packet is then forwarded from the NVD. For example, the packet may be forwarded from the NVD to another NVD associated with a host machine that is the intended recipient of the packet.

In certain NVD implementations, multiple processing planes are provided with differing processing characteristics. For example, in certain implementations, an NVD may include two different packet processing planes with different processing capabilities. For example, the NVD may include: (1) a slow path plane, and (2) an accelerated plane (also referred to as a fast path plane). The NVD thus provides two separate processing planes for processing packets received by the NVD. Processing of packets received by the NVD may be performed by one or both of the processing planes.

As its name implies, the accelerated plane is one that is able to process packets faster than the slow path plane. For example, the accelerated path plane comprises processing components/units that are able to perform certain actions or functions faster than the processing components/units of the slow path plane. In certain NVD implementations, the slow path plane comprises multiple processors or cores, such as ARM cores (Advanced Reduced Instruction Set Computing (RISC) Machine architecture cores), while the accelerated path plane comprises specialized multiple microprocessor units (MPUs), one or several ASICs such as one or several programmable ASICs, or the like. The MPUs and/or ASICs in the accelerated path plane can be programmable and can operate using code that can be custom code. In some embodiments, the MPUs and/or ASICs in the accelerated path plane may run P4 code for performing various network functions (e.g., encapsulation of packets, decapsulation of packets). P4 is a programming language that is typically used for performing packet processing functions in forwarding planes in networking devices. In contrast to general purpose languages such as C or Python, P4 is a domain-specific language with a number of constructs optimized for network data forwarding. Accordingly, the accelerated path plane may be able to process packets faster than the slow path plane. For example, in certain implementations, the accelerated path plane can process 40 million PPS (packets per second), while the slow path plane comprising ARM cores can do about 10 million PPS. The accelerated path plane is thus much faster than the slow path plane and offers ultra-low latency. The MPUs and/or ASICs can be organized into groups of MPUs and/or ASICs and different pipelines of MPUs and/or ASICs. MPUs and/or ASICs can run multiple stages and a packet could be processed by multiple MPUs and/or ASICs. There could be a pipeline of actions performed by multiple MPUs and/or ASICs. While performance of the MPUs and/or ASICs is faster than the ARM cores, the ARM cores may offer more flexibility in their programming. Thus, the type of processing units in the slow path plane are of a different type than the processing units in the accelerated path plane.

The networking-related processing performed by an NVD can be categorized as data plane (DP) related processing or control plane (CP) related processing. Control plane-related processing typically includes functions for configuring a network such as setting up routes and route tables, configuring network interface cards/controllers (NICs) and virtual network interface cards/controllers (vNICs or VNICs)), etc., which control how data is to be forwarded. Data plane-related processing typically includes functions for routing/forwarding a packet received by the NVD based upon configuration set up using control plane processing. In a typical networking environment, a vast majority of the packet processing performed by an NVD is data plane-related processing with a small amount of control plane-related processing. For example, in several typical use cases, about 90% of the overall packet processing performed by an NVD is data plane-related processing and only about 10% of the overall packet processing is control plane-related processing. Accordingly, for better performance, NVDs are designed such that the slow path plane is used primarily for performing control plane (CP) related processing and for minimal data plane-related processing, and the bulk of the data plane-related processing is performed by the accelerated path plane. As a result, the slow path plane has the intelligence of owning the network traffic flows and the states of the flows.

A network traffic flow (also referred to as a “network flow” or “traffic flow” or just “flow”) typically identifies packets communicated between two specific endpoints. Various different techniques may be used to determine a traffic flow for a received packet. Typically, information from the header of the received packet is used to determine the traffic flow to which the packet belongs. In certain implementations, a 6-tuple from the packet header is used to determine a traffic flow for the packet, where the 6-tuple includes the source IP address, the source port number, the destination IP address, the destination port number, the protocol in use, and the Virtual Network Interface Card identifier (VNIC ID). In certain implementations, a 5-tuple is used to determine the traffic flow to which the packet belongs, where the 5-tuple comprises the source IP address, the source port number, the destination IP address, the destination port number, and the protocol. Various other techniques based upon information in a packet's header may be used to determine a network flow for a packet.

Since the slow path plane performs the control plane-related functions, in certain implementations, the slow path plane on an NVD is configured to program the accelerated path plane for data plane-related processing for each new traffic flow. When the NVD receives a packet for a new flow (i.e., the first packet received by the NVD for that traffic flow), the packet is processed by the slow path plane. The slow path plane then programs the accelerated path plane for that new traffic flow such that subsequent packets belonging to that traffic flow are processed by the accelerated path plane instead of by the slow path plane.

For example, in certain implementations, the following processing is performed when the NVD receives a packet for a new traffic flow (i.e., receives the first packet for a traffic flow).
(1) NVD receives a packet via a port of the NVD.
(2) The packet is forwarded to the accelerated path plane for processing.
(3) The accelerated path plane checks if the received packet belongs to a known traffic flow (i.e., is not the first packet received for that flow) for which the accelerated path plane has previously been programmed by the slow path plane. The 6-tuple or the 5-tuple determined from the header (e.g., encapsulated header) of the received packet may be used to determine the flow to which the packet belongs. Upon determining that the received packet belongs to a known flow, the accelerated path plane processes the packet. For a packet belonging to a known flow, as part of its processing, the accelerated path plane may perform one or more actions on the packet, and the packet may then be forwarded from the NVD, and processing of the packet by the NVD is completed. For example, the packet may be forwarded from the NVD to another NVD associated with the host machine that is the intended recipient of the packet. If it is determined that the packet belongs to a new flow, the accelerated path plane forwards the packet to the slow path plane for processing.
(4) As indicated above, in the scenario where the received packet is the first packet in a traffic flow, i.e., belongs to a new traffic flow, and the accelerated path plane has not been previously programmed by the slow path plane for that flow, the packet is forwarded to the slow path plane for processing. The packet may be processed by one of the multiple cores (e.g., ARM cores) of the slow path plane. For example, if the slow path plane comprises sixteen (16) ARM cores, a particular ARM core from the sixteen cores is selected and the selected core then processes the packet. Different techniques may be used to select a particular core for processing the packet. In certain implementations, a Receive Side Scaling (RSS) hashing technique is used to select a particular core from among the multiple cores of the slow path plane for processing the packet. The 5-tuple (or 6-tuple) of the packet is determined and hashed using an RSS hashing technique, such as a 16-bit RSS hash. The resultant hash value is then used to select a particular core from the multiple cores of the slow path plane. As a result, packets belonging to the same flow get hashed to the same core from the multiple cores of the slow path plane and you do not have to worry about packet reordering. As part of its processing, the selected core may determine that the received packet belongs to a new traffic flow. In certain implementations, the core performs “match-action processing” to determine the actions to be performed for the packet. As part of this processing, the core matches various things such as the 6-tuple, which customer the packet is received from, etc. and determines one or more actions to be performed on the packet. The particular core then performs the one or more actions or operations, and the packet is then forwarded from the NVD. For example, the packet may be forwarded from the NVD to another network device to facilitate the communication of the packet to its intended destination. For example, the packet may be forwarded from the NVD to another NVD associated with the host machine that is the intended recipient of the packet. The particular core of the slow path plane then programs the accelerated path plane for the new traffic flow corresponding to the received packet so that subsequent packets belonging to that same traffic flow can be processed by the accelerated path plane without the slow path plane being involved.

When the selected core from the slow path plane processes a packet, the core may build and use one or more data or memory structures storing information that is used by the core to process the packet. These data structure may store information related to the traffic flow, and other information. These data structures may be built by the selected core and cached in one or more caches local to or associated with the selected core (e.g., L2 and/or L3 cache of that selected core). The caches may thus store flow state information for the flows being processed such as timeout data, statistical data about the flow, routing information, n-tuple hash information, etc. Since caches are typically at least 20× or 30× faster than using DRAM, the performance gains obtained from using these caches is better than using DRAM.

There are situations where, after the slow path plane has already programmed the accelerated path plane to handle a traffic flow and data plane-related processing is performed by the accelerated path plane, the slow path plane has to sometimes perform processing for that flow. There are various situations when this may occur. For example, since the slow path plane performs control plane-related processing, there are certain control plane actions related to flows that the slow path plane has to perform. Examples of such actions include performing logging for a flow, deleting a flow when the flow expires, and other control plane functions. As additional examples, in some situations, the accelerated path plane may be unable to perform some of its functions and the slow path plane may then have to take over one or all functions performed by the accelerated path plane. This may happen, for example, when the accelerated path plane is shut down or not operational due to the presence of software or hardware problems, or when the accelerated path plane is shut down for performing a software/hardware upgrade, etc.

In such situations, when the slow path plane has to perform an action for a flow whose processing is otherwise handled by the accelerated path plane, it is preferable that the processing be performed by the same particular core of the slow path plane that performed the processing for the first received packet for that flow and which resulted in the programming of the accelerated path plane for that flow. This is because, as mentioned earlier, the particular core may have cached flow-related data structures that were used by the core to process previous packets related to the flow, such as the first received packet for the flow. These data structures may still persist in the one or more caches associated with that core. These data structures may store state information for the flow such as timeout data, statistical data about the flow, routing information, n-tuple hash information, etc. Accordingly, if the same core performs the processing now, the core can reuse and take advantage of these already cached and available data structures storing flow state information. If instead, the processing was performed by some other core of the slow path plane, that other core would have to rebuild these data structures in order to perform the processing. This rebuilding of the data structures and associated flow information can take time and thus add unwanted latency to the processing performed by the slow path plane making the processing slower. Accordingly, it is preferable that the processing be performed by the same core so that the core can leverage the data structures stored in its cache(s) and be able to perform the flow-related processing in a faster manner with reduced latency. Also, all these data structures are not thread-safe and give higher performance.

The slow path may further perform an action for a flow when, after programming the fast path, the configuration of the flow is in some way changed. In such a circumstance, the previous programming of the fast path for handling the flow can be invalidated, also described herein as “invalidating the flow.” When a flow has been invalidated, subsequent packets in that flow must be processed by the slow path, and the fast path must be reprogrammed. Thus, the invalidation of a flow shifts the processing burden from the fast path and back to the slow path.

Under many circumstances, this shifting of the processing burden for a flow from the fast path to the slow path can proceed without problem. However, in circumstances in which a large number of flows are invalidated, and a large processing burden can, in a short amount of time, be shifted from the fast path to the slow path. In certain circumstances, the amount of processing burden can be sufficient to overwhelm the slow path and can present a thundering herd problem. In the event that the processing capability of the slow path is overwhelmed, processing of packets can be delayed, and in some instances, packets can be dropped. The dropping of these packets is undesirable.

However, the effects of flow invalidation can be ameliorated by providing a workflow in which a change in configuration for a flow does not immediately invalidate that flow, but rather starts an invalidation process in which the fast path can continue to process packets under the previous programming while the slow path is reprogramming the fast path. Such a flow thus prevents the shift of all processing to the slow path and allows the fast path to continue processing packets, as before, for some certain amount of time. This amount of time can be predetermined and/or preselected to be of sufficient duration to allow the slow path time to reprogram the fast path before the flow is invalidated. in such an embodiment, the flow can then be invalidated when the fast path has been reprogrammed, or when more than the predetermined and/or preselected duration of time has passed.

The present disclosure describes techniques that enable such improved flow invalidation. Specifically, the present disclosure describes, receiving a packet at a fast path, the packet belonging to a flow for which the fast path was previously programmed. The fast path can determine that an indicator is associated with this flow, which indicator identifies the flow as being “soft invalidated”, interchangeably referred to herein as being “provisionally invalidated.” As used herein, a “soft invalidation” is a status for flows that have been identified for invalidation after the passing of a predetermined and/or preselected duration of time. This soft invalidation can be the result of, for example, a change in configuration for the flow.

After determining that the flow has been soft invalidated, the fast path can send a packet including all or portions of the information from the received packet to the slow path. This packet, referred to herein as a “probe packet” can be a copy of the packet received by the fast path, or can be a copy of portions of the packet received by the fast path. In some embodiments, the probe packet can be a copy of the packet received by the fast path but excluding the payload of the packet. In some embodiments, the probe packet can be a copy of all or portions of header information from the packet received by the fast path.

Upon receipt of the probe, the slow packet can process the probe packet according to the change in configuration for the flow, and can reprogram the fast path accordingly. After the fast path has been reprogrammed, the fast path can begin processing subsequent received packets in the flow according to the updated programming.

Alternatively, if the slow path does not reprogram the fast path within a predetermined and/or preselected period of time, then the flow is invalidated, or in other words, the status of the flow is changed from soft invalidated to invalidated. Any packets received by the fast path for the flow after the status of the flow has changed from soft invalidated to invalidated are dropped by the fast path.

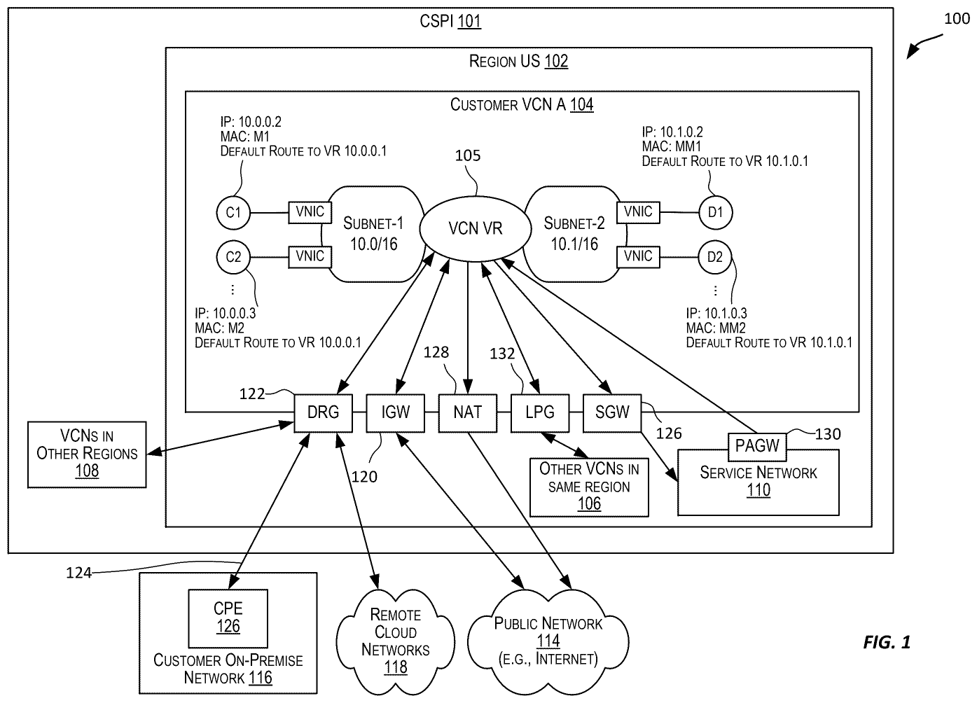

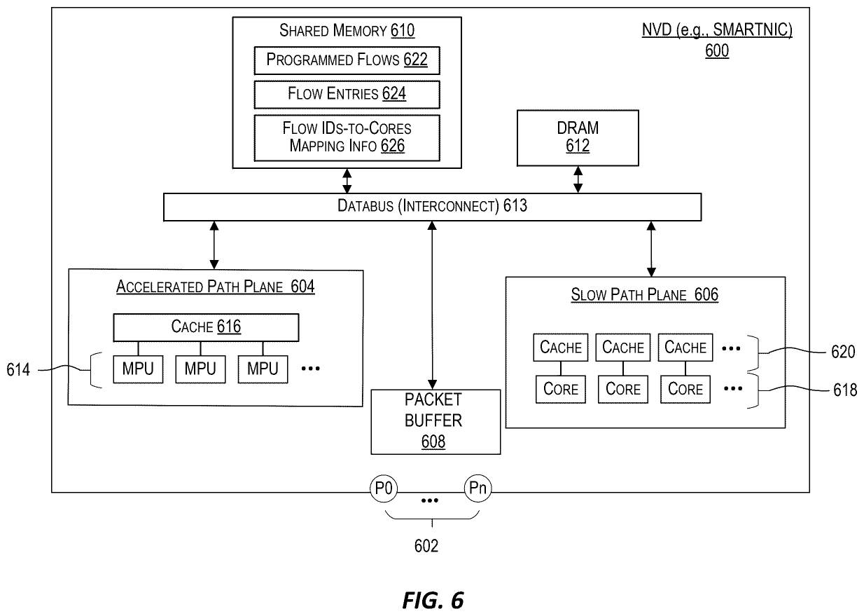

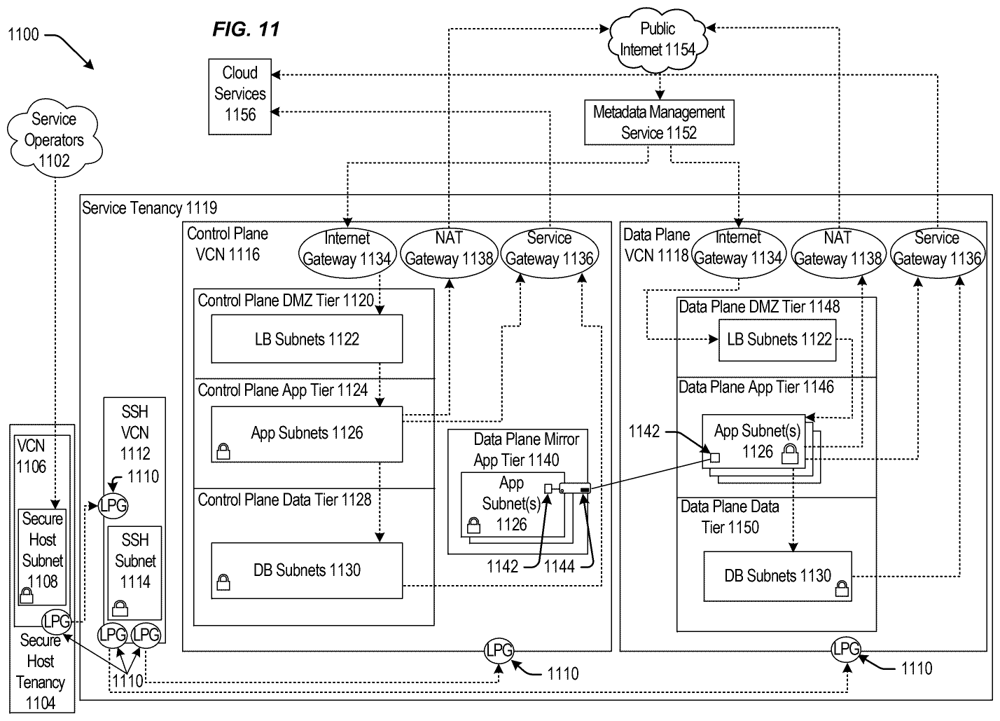

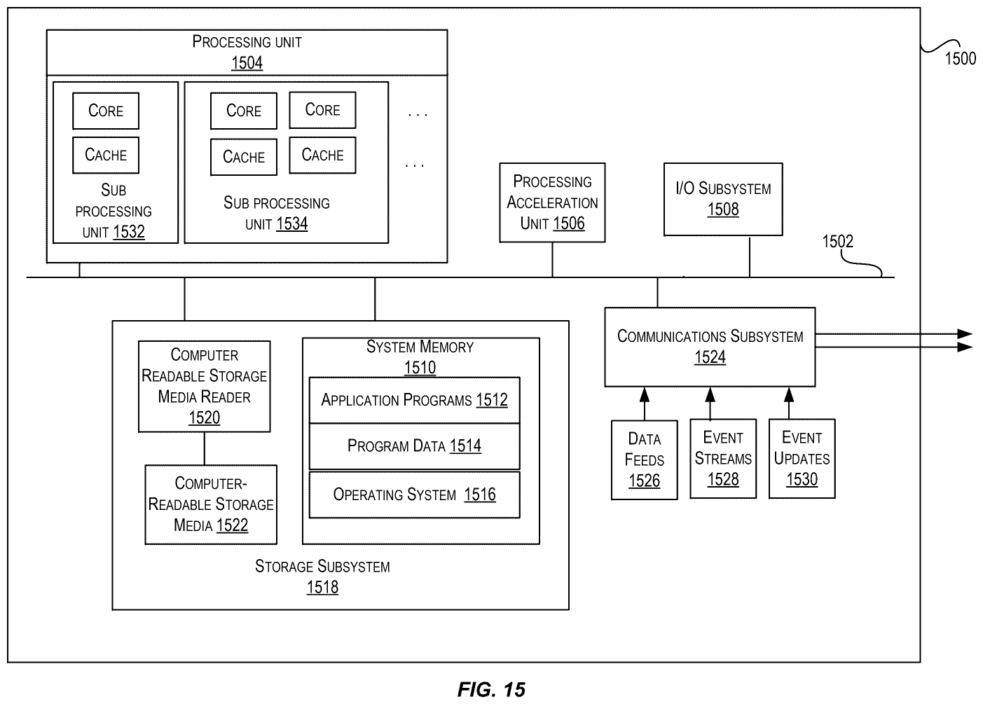

FIGS. 1-5 and the associated description provided in the “Example Virtual Networking Environment and Architecture” section below describes networking concepts including virtualization, overlay networks, network virtualization devices (NVDs) and their usage, and provides examples of environments in which NVDs implementing the improved techniques disclosed in this disclosure may be used. FIGS. 6-10 describe examples and embodiments related to the improved techniques described in this disclosure. FIGS. 11-14 depict examples of architectures for implementing cloud infrastructures for providing one or more cloud services, where the infrastructures may incorporate teachings described herein. FIG. 15 depicts a block diagram illustrating an example computer system, according to at least one embodiment. While the various embodiments and examples in this disclosure describe NVDs with two processing planes, namely, a slow path plane and an accelerated path plane, this is not intended to be limiting. In alternative embodiments, more than two processing planes may be provided with different processing capabilities. While the various embodiments and examples in this disclosure describe a slow path plane comprising cores and an accelerated path plane comprising MPUs and/or ASICs, this is also not intended to be limiting. In general, each processing plane may comprise multiple processing units.

### Example Virtual Networking Architecture

The term cloud service is generally used to refer to a service that is made available by a cloud services provider (CSP) to users or customers on demand (e.g., via a subscription model) using systems and infrastructure (cloud infrastructure) provided by the CSP. Typically, the servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services.

There are several cloud service providers that offer various types of cloud services. There are various different types or models of cloud services including Software-as-a-Service (SaaS), Platform-as-a-Service (PaaS), Infrastructure-as-a-Service (IaaS), and others.

A customer can subscribe to one or more cloud services provided by a CSP. The customer can be any entity such as an individual, an organization, an enterprise, and the like. When a customer subscribes to or registers for a service provided by a CSP, a tenancy or an account is created for that customer. The customer can then, via this account, access the subscribed-to one or more cloud resources associated with the account.

As noted above, infrastructure as a service (IaaS) is one particular type of cloud computing service. In an IaaS model, the CSP provides infrastructure (referred to as cloud services provider infrastructure or CSPI) that can be used by customers to build their own customizable networks and deploy customer resources. The customer's resources and networks are thus hosted in a distributed environment by infrastructure provided by a CSP. This is different from traditional computing, where the customer's resources and networks are hosted by infrastructure provided by the customer.

The CSPI may comprise interconnected high-performance compute resources including various host machines, memory resources, and network resources that form a physical network, which is also referred to as a substrate network or an underlay network. The resources in CSPI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CSPI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)), Virtual Extensible LAN (VXLAN-IETF RFC 7348), Virtual Private Networks (VPNs) (e.g., MPLS Layer-3 Virtual Private Networks (RFC 4364)), VMware's NSX, GENEVE (Generic Network Virtualization Encapsulation), and others.

For IaaS, the infrastructure (CSPI) provided by a CSP can be configured to provide virtualized computing resources over a public network (e.g., the Internet). In an IaaS model, a cloud computing services provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance. CSPI provides infrastructure and a set of complementary cloud services that enable customers to build and run a wide range of applications and services in a highly available hosted distributed environment. CSPI offers high-performance compute resources and capabilities and storage capacity in a flexible virtual network that is securely accessible from various networked locations such as from a customer's on-premises network. When a customer subscribes to or registers for an IaaS service provided by a CSP, the tenancy created for that customer is a secure and isolated partition within the CSPI where the customer can create, organize, and administer their cloud resources.

Customers can build their own virtual networks using compute, memory, and networking resources provided by CSPI. One or more customer resources or workloads, such as compute instances, can be deployed on these virtual networks. For example, a customer can use resources provided by CSPI to build one or multiple customizable and private virtual network(s) referred to as virtual cloud networks (VCNs). A customer can deploy one or more customer resources, such as compute instances, on a customer VCN. Compute instances can take the form of virtual machines, bare metal instances, and the like. The CSPI thus provides infrastructure and a set of complementary cloud services that enable customers to build and run a wide range of applications and services in a highly available virtual hosted environment. The customer does not manage or control the underlying physical resources provided by CSPI but has control over operating systems, storage, and deployed applications; and possibly limited control of select networking components (e.g., firewalls).

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) serves a single customer or tenant. In a multi-tenancy architecture, a software or a hardware component serves multiple customers or tenants. Thus, in a multi-tenancy architecture, CSPI resources are shared between multiple customers or tenants. In a multi-tenancy situation, precautions are taken and safeguards put in place within CSPI to ensure that each tenant's data is isolated and remains invisible to other tenants.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CSPI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that is represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CSPI is physically hosted in one or more data centers in one or more regions around the world. The CSPI may include components in the physical or substrate network and virtualized components (e.g., virtual networks, compute instances, virtual machines, etc.) that are in an virtual network built on top of the physical network components. In certain embodiments, the CSPI is organized and hosted in realms, regions and availability domains. A region is typically a localized geographic area that contains one or more data centers. Regions are generally independent of each other and can be separated by vast distances, for example, across countries or even continents. For example, a first region may be in Australia, another one in Japan, yet another one in India, and the like. CSPI resources are divided among regions such that each region has its own independent subset of CSPI resources. Each region may provide a set of core infrastructure services and resources, such as, compute resources (e.g., bare metal servers, virtual machine, containers and related infrastructure, etc.); storage resources (e.g., block volume storage, file storage, object storage, archive storage); networking resources (e.g., virtual cloud networks (VCNs), load balancing resources, connections to on-premise networks), database resources; edge networking resources (e.g., DNS); and access management and monitoring resources, and others. Each region generally has multiple paths connecting it to other regions in the realm.

Generally, an application is deployed in a region (i.e., deployed on infrastructure associated with that region) where it is most heavily used, because using nearby resources is faster than using distant resources. Applications can also be deployed in different regions for various reasons, such as redundancy to mitigate the risk of region-wide events such as large weather systems or earthquakes, to meet varying requirements for legal jurisdictions, tax domains, and other business or social criteria, and the like.

The data centers within a region can be further organized and subdivided into availability domains (ADs). An availability domain may correspond to one or more data centers located within a region. A region can be composed of one or more availability domains. In such a distributed environment, CSPI resources are either region-specific, such as a virtual cloud network (VCN), or availability domain-specific, such as a compute instance.

ADs within a region are isolated from each other, fault tolerant, and are configured such that they are very unlikely to fail simultaneously. This is achieved by the ADs not sharing critical infrastructure resources such as networking, physical cables, cable paths, cable entry points, etc., such that a failure at one AD within a region is unlikely to impact the availability of the other ADs within the same region. The ADs within the same region may be connected to each other by a low latency, high bandwidth network, which makes it possible to provide high-availability connectivity to other networks (e.g., the Internet, customers'on-premise networks, etc.) and to build replicated systems in multiple ADs for both high-availability and disaster recovery. Cloud services use multiple ADs to ensure high availability and to protect against resource failure. As the infrastructure provided by the IaaS provider grows, more regions and ADs may be added with additional capacity. Traffic between availability domains is usually encrypted.

In certain embodiments, regions are grouped into realms. A realm is a logical collection of regions. Realms are isolated from each other and do not share any data. Regions in the same realm may communicate with each other, but regions in different realms cannot. A customer's tenancy or account with the CSP exists in a single realm and can be spread across one or more regions that belong to that realm. Typically, when a customer subscribes to an IaaS service, a tenancy or account is created for that customer in the customer-specified region (referred to as the “home” region) within a realm. A customer can extend the customer's tenancy across one or more other regions within the realm. A customer cannot access regions that are not in the realm where the customer's tenancy exists.

An IaaS provider can provide multiple realms, each realm catered to a particular set of customers or users. For example, a commercial realm may be provided for commercial customers. As another example, a realm may be provided for a specific country for customers within that country. As yet another example, a government realm may be provided for a government, and the like. For example, the government realm may be catered for a specific government and may have a heightened level of security than a commercial realm. For example, Oracle Cloud Infrastructure (OCI) currently offers a realm for commercial regions and two realms (e.g., FedRAMP authorized and IL5 authorized) for government cloud regions.

In certain embodiments, an AD can be subdivided into one or more fault domains. A fault domain is a grouping of infrastructure resources within an AD to provide anti-affinity. Fault domains allow for the distribution of compute instances such that the instances are not on the same physical hardware within a single AD. This is known as anti-affinity. A fault domain refers to a set of hardware components (computers, switches, and more) that share a single point of failure. A compute pool is logically divided up into fault domains. Due to this, a hardware failure or compute hardware maintenance event that affects one fault domain does not affect instances in other fault domains. Depending on the embodiment, the number of fault domains for each AD may vary. For instance, in certain embodiments each AD contains three fault domains. A fault domain acts as a logical data center within an AD.

When a customer subscribes to an IaaS service, resources from CSPI are provisioned for the customer and associated with the customer's tenancy. The customer can use these provisioned resources to build private networks and deploy resources on these networks. The customer networks that are hosted in the cloud by the CSPI are referred to as virtual cloud networks (VCNs). A customer can set up one or more virtual cloud networks (VCNs) using CSPI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with public accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints.

The CSP may provide various services using the CSPI. In some instances, customers of CSPI may themselves act like service providers and provide services using CSPI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints.

In certain embodiments, a service provider may expose a service via an endpoint (sometimes referred to as a service endpoint) for the service. Customers of the service can then use this service endpoint to access the service. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 10.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general, a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 1. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 10.0/16 and 10.1/16, respectively. For the first subnet within the VCN with address range 10.0/16, an address from this range is reserved for a port of the VCN VR for that subnet. In some instances, the first IP address from the range may be reserved for the VCN VR. For example, for the subnet with overlay IP address range 10.0/16, IP address 10.0.0.1 may be reserved for a port of the VCN VR for that subnet. For the second subnet within the same VCN with address range 10.1/16, the VCN VR may have a port for that second subnet with IP address 10.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about: the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

In certain embodiments, the creation of VCNs and subnets are handled by a VCN Control Plane (CP) and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane. Examples of a VCN Control Plane are also depicted in FIGS. 11, 12, 13, and 14 (see references 1116, 1216, 1316, and 1416) and described below.

A customer may create one or more VCNs using resources hosted by CSPI. A compute instance deployed on a customer VCN may communicate with different endpoints. These endpoints can include endpoints that are hosted by CSPI and endpoints outside CSPI.

Various different architectures for implementing cloud-based service using CSPI are depicted in FIGS. 1, 2, 3, 4, 5, 11, 12, 13, and 15, and are described below. FIG. 1 is a high level diagram of a distributed environment 100 showing an overlay or customer VCN hosted by CSPI according to certain embodiments. The distributed environment depicted in FIG. 1 includes multiple components in the overlay network. Distributed environment 100 depicted in FIG. 1 is merely an example and is not intended to unduly limit the scope of claimed embodiments. Many variations, alternatives, and modifications are possible. For example, in some implementations, the distributed environment depicted in FIG. 1 may have more or fewer systems or components than those shown in FIG. 1, may combine two or more systems, or may have a different configuration or arrangement of systems.

As shown in the example depicted in FIG. 1, distributed environment 100 comprises CSPI 101 that provides services and resources that customers can subscribe to and use to build their virtual cloud networks (VCNs). In certain embodiments, CSPI 101 offers IaaS services to subscribing customers. The data centers within CSPI 101 may be organized into one or more regions. One example region “Region US” 102 is shown in FIG. 1. A customer has configured a customer VCN 104 for region 102. The customer may deploy various compute instances on VCN 104, where the compute instances may include virtual machines or bare metal instances. Examples of instances include applications, database, load balancers, and the like.

In the embodiment depicted in FIG. 1, customer VCN 104 comprises two subnets, namely, “Subnet-1” and “Subnet-2”, each subnet with its own CIDR IP address range. In FIG. 1, the overlay IP address range for Subnet-1 is 10.0/16 and the address range for Subnet-2 is 10.1/16. A VCN Virtual Router 105 represents a logical gateway for the VCN that enables communications between subnets of the VCN 104, and with other endpoints outside the VCN. VCN VR 105 is configured to route traffic between VNICs in VCN 104 and gateways associated with VCN 104. VCN VR 105 provides a port for each subnet of VCN 104. For example, VR 105 may provide a port with IP address 10.0.0.1 for Subnet-1 and a port with IP address 10.1.0.1 for Subnet-2.

Multiple compute instances may be deployed on each subnet, where the compute instances can be virtual machine instances, and/or bare metal instances. The compute instances in a subnet may be hosted by one or more host machines within CSPI 101. A compute instance participates in a subnet via a VNIC associated with the compute instance. For example, as shown in FIG. 1, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 1, compute instance C1 has an overlay IP address of 10.0.0.2 and a MAC address of M1, while compute instance C2 has an private overlay IP address of 10.0.0.3 and a MAC address of M2. Each compute instance in Subnet-1, including compute instances C1 and C2, has a default route to VCN VR 105 using IP address 10.0.0.1, which is the IP address for a port of VCN VR 105 for Subnet-1.

Subnet-2 can have multiple compute instances deployed on it, including virtual machine instances and/or bare metal instances. For example, as shown in FIG. 1, compute instances D1 and D2 are part of Subnet-2 via VNICs associated with the respective compute instances. In the embodiment depicted in FIG. 1, compute instance D1 has an overlay IP address of 10.1.0.2 and a MAC address of MM1, while compute instance D2 has an private overlay IP address of 10.1.0.3 and a MAC address of MM2. Each compute instance in Subnet-2, including compute instances D1 and D2, has a default route to VCN VR 105 using IP address 10.1.0.1, which is the IP address for a port of VCN VR 105 for Subnet-2.

VCN A 104 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 104 can communicate with various different endpoints. These endpoints may include endpoints that are hosted by CSPI 200 and endpoints outside CSPI 200. Endpoints that are hosted by CSPI 101 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN in the same region 106 or 110, communications between a compute instance in Subnet-1 and an endpoint in service network 110 in the same region); or an endpoint in a VCN in a different region (e.g., communications between a compute instance in Subnet-1 and an endpoint in a VCN in a different region 108). A compute instance in a subnet hosted by CSPI 101 may also communicate with endpoints that are not hosted by CSPI 101 (i.e., are outside CSPI 101). These outside endpoints include endpoints in the customer's on-premise network 116, endpoints within other remote cloud hosted networks 118, public endpoints 114 accessible via a public network such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 1 wants to send a packet to compute instance D1 in Subnet-2, the packet is first processed by the VNIC associated with compute instance C1. The VNIC associated with compute instance C1 is configured to route the packet to the VCN VR 105 using default route or port 10.0.0.1 of the VCN VR. VCN VR 105 is configured to route the packet to Subnet-2 using port 10.1.0.1. The packet is then received and processed by the VNIC associated with D1 and the VNIC forwards the packet to compute instance D1.

For a packet to be communicated from a compute instance in VCN 104 to an endpoint that is outside VCN 104, the communication is facilitated by the VNIC associated with the source compute instance, VCN VR 105, and gateways associated with VCN 104. One or more types of gateways may be associated with VCN 104. A gateway is an interface between a VCN and another endpoint, where the another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 104. The packet may be first processed by the VNIC associated with source compute instance C1. The VNIC processing determines that the destination for the packet is outside the Subnet-1 of C1. The VNIC associated with C1 may forward the packet to VCN VR 105 for VCN 104. VCN VR 105 then processes the packet and as part of the processing, based upon the destination for the packet, determines a particular gateway associated with VCN 104 as the next hop for the packet. VCN VR 105 may then forward the packet to the particular identified gateway. For example, if the destination is an endpoint within the customer's on-premise network, then the packet may be forwarded by VCN VR 105 to Dynamic Routing Gateway (DRG) gateway 122 configured for VCN 104. The packet may then be forwarded from the gateway to a next hop to facilitate communication of the packet to it final intended destination.

Various different types of gateways may be configured for a VCN. Examples of gateways that may be configured for a VCN are depicted in FIG. 1 and described below. Examples of gateways associated with a VCN are also depicted in FIGS. 11, 12, 13, and 14 (for example, gateways referenced by reference numbers 1134, 1136, 1138, 1234, 1236, 1238, 1334, 1336, 1338, 1434, 1436, and 1438) and described below. As shown in the embodiment depicted in FIG. 1, a Dynamic Routing Gateway (DRG) 122 may be added to or be associated with customer VCN 104 and provides a path for private network traffic communication between customer VCN 104 and another endpoint, where the another endpoint can be the customer's on-premise network 116, a VCN 108 in a different region of CSPI 101, or other remote cloud networks 118 not hosted by CSPI 101. Customer on-premise network 116 may be a customer network or a customer data center built using the customer's resources. Access to customer on-premise network 116 is generally very restricted. For a customer that has both a customer on-premise network 116 and one or more VCNs 104 deployed or hosted in the cloud by CSPI 101, the customer may want their on-premise network 116 and their cloud-based VCN 104 to be able to communicate with each other. This enables a customer to build an extended hybrid environment encompassing the customer's VCN 104 hosted by CSPI 101 and their on-premises network 116. DRG 122 enables this communication. To enable such communications, a communication channel 124 is set up where one endpoint of the channel is in customer on-premise network 116 and the other endpoint is in CSPI 101 and connected to customer VCN 104. Communication channel 124 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 116 that forms one end point for communication channel 124 is referred to as the customer premise equipment (CPE), such as CPE 126 depicted in FIG. 1. On the CSPI 101 side, the endpoint may be a host machine executing DRG 122.

In certain embodiments, a Remote Peering Connection (RPC) can be added to a DRG, which allows a customer to peer one VCN with another VCN in a different region. Using such an RPC, customer VCN 104 can use DRG 122 to connect with a VCN 108 in another region. DRG 122 may also be used to communicate with other remote cloud networks 118, not hosted by CSPI 101 such as a Microsoft Azure cloud, Amazon AWS cloud, and others.

As shown in FIG. 1, an Internet Gateway (IGW) 120 may be configured for customer VCN 104 the enables a compute instance on VCN 104 to communicate with public endpoints 114 accessible over a public network such as the Internet. IGW 120 is a gateway that connects a VCN to a public network such as the Internet. IGW 120 enables a public subnet (where the resources in the public subnet have public overlay IP addresses) within a VCN, such as VCN 104, direct access to public endpoints 112 on a public network 114 such as the Internet. Using IGW 120, connections can be initiated from a subnet within VCN 104 or from the Internet.

A Network Address Translation (NAT) gateway 128 can be configured for customer's VCN 104 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 104, with private access to public endpoints on the Internet. In NAT gateways, connections can be initiated only from the private subnet to the public Internet and not from the Internet to the private subnet.

In certain embodiments, a Service Gateway (SGW) 126 can be configured for customer VCN 104 and provides a path for private network traffic between VCN 104 and supported services endpoints in a service network 110. In certain embodiments, service network 110 may be provided by the CSP and may provide various services. An example of such a service network is Oracle's Services Network, which provides various services that can be used by customers. For example, a compute instance (e.g., a database system) in a private subnet of customer VCN 104 can back up data to a service endpoint (e.g., Object Storage) without needing public IP addresses or access to the Internet. In certain embodiments, a VCN can have only one SGW, and connections can only be initiated from a subnet within the VCN and not from service network 110. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 126 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 132 is a gateway that can be added to customer VCN 104 and enables VCN 104 to peer with another VCN in the same region. Peering means that the VCNs communicate using private IP addresses, without the traffic traversing a public network such as the Internet or without routing the traffic through the customer's on-premises network 116. In preferred embodiments, a VCN has a separate LPG for each peering it establishes. Local Peering or VCN Peering is a common practice used to establish network connectivity between different applications or infrastructure management functions.

Service providers, such as providers of services in service network 110, may provide access to services using different access models. According to a public access model, services may be exposed as public endpoints that are publicly accessible by compute instance in a customer VCN via a public network such as the Internet and or may be privately accessible via SGW 126. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 130 is a gateway resource that can be attached to a service provider VCN (e.g., a VCN in service network 110) that acts as an ingress/egress point for all traffic from/to customer subnet private endpoints. PAGW 130 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 130 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 132 and the PE in the customer's VCN.

A customer can control routing in a VCN at the subnet level, so the customer can specify which subnets in the customer's VCN, such as VCN 104, use each gateway. A VCN's route tables are used to decide if traffic is allowed out of a VCN through a particular gateway. For example, in a particular instance, a route table for a public subnet within customer VCN 104 may send non-local traffic through IGW 120. The route table for a private subnet within the same customer VCN 104 may send traffic destined for CSP services through SGW 126. All remaining traffic may be sent via the NAT gateway 128. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked and the response is automatically allowed without an explicit security list rule for the response traffic) or stateless.

Access from a customer VCN (i.e., by a resource or compute instance deployed on VCN 104) can be categorized as public access, private access, or dedicated access. Public access refers to an access model where a public IP address or a NAT is used to access a public endpoint. Private access enables customer workloads in VCN 104 with private IP addresses (e.g., resources in a private subnet) to access services without traversing a public network such as the Internet. In certain embodiments, CSPI 101 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CSPI may offer dedicated public access using technologies such as FastConnect public peering where customer on-premises instances can access one or more services in a customer VCN using a FastConnect connection and without traversing a public network such as the Internet. CSPI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CSPI and its services. FastConnect provides an easy, elastic, and economical way to create a dedicated and private connection with higher bandwidth options and a more reliable and consistent networking experience when compared to Internet-based connections.

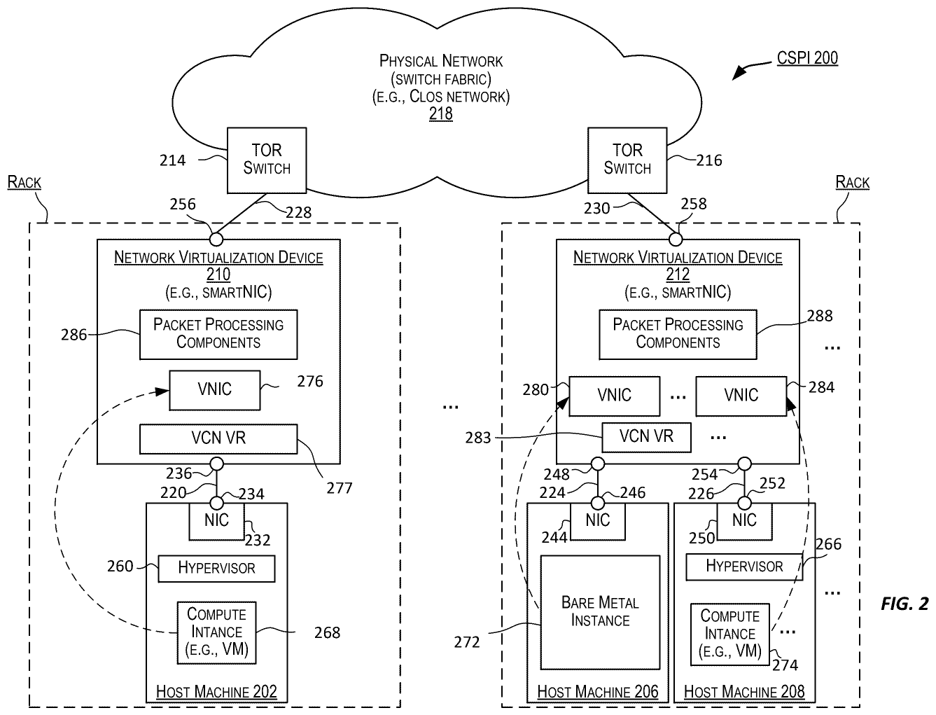

FIG. 1 and the accompanying description above describes various virtualized components in an example virtual network. As described above, the virtual network is built on the underlying physical or substrate network. FIG. 2 depicts a simplified architectural diagram of the physical components in the physical network within CSPI 200 that provide the underlay for the virtual network according to certain embodiments. As shown, CSPI 200 provides a distributed environment comprising components and resources (e.g., compute, memory, and networking resources) provided by a cloud service provider (CSP). These components and resources are used to provide cloud services (e.g., IaaS services) to subscribing customers, i.e., customers that have subscribed to one or more services provided by the CSP. Based upon the services subscribed to by a customer, a subset of resources (e.g., compute, memory, and networking resources) of CSPI 200 are provisioned for the customer. Customers can then build their own cloud-based (i.e., CSPI-hosted) customizable and private virtual networks using physical compute, memory, and networking resources provided by CSPI 200. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CSPI 200 provides infrastructure and a set of complementary cloud services that enable customers to build and run a wide range of applications and services in a highly available hosted environment.

In the example embodiment depicted in FIG. 2, the physical components of CSPI 200 include one or more physical host machines or physical servers (e.g., 202, 206, 208), network virtualization devices (NVDs) (e.g., 210, 212), top-of-rack (TOR) switches (e.g., 214, 216), and a physical network (e.g., 218), and switches in physical network 218. The physical host machines or servers may host and execute various compute instances that participate in one or more subnets of a VCN. The compute instances may include virtual machine instances, and bare metal instances. For example, the various compute instances depicted in FIG. 1 may be hosted by the physical host machines depicted in FIG. 2. The virtual machine compute instances in a VCN may be executed by one host machine or by multiple different host machines. The physical host machines may also host virtual host machines, container-based hosts or functions, and the like. The VNICs and VCN VR depicted in FIG. 1 may be executed by the NVDs depicted in FIG. 2. The gateways depicted in FIG. 1 may be executed by the host machines and/or by the NVDs depicted in FIG. 2.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 2, host machines 202 and 208 execute hypervisors 260 and 266, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 2, hypervisor 260 may sit on top of the OS of host machine 202 and enables the computing resources (e.g., processing, memory, and networking resources) of host machine 202 to be shared between compute instances (e.g., virtual machines) executed by host machine 202. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 2 may have the same or different types of hypervisors.

A compute instance can be a virtual machine instance or a bare metal instance. In FIG. 2, compute instances 268 on host machine 202 and 274 on host machine 208 are examples of virtual machine instances. Host machine 206 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 2, host machine 202 executes a virtual machine compute instance 268 that is associated with VNIC 276, and VNIC 276 is executed by NVD 210 connected to host machine 202. As another example, bare metal instance 272 hosted by host machine 206 is associated with VNIC 280 that is executed by NVD 212 connected to host machine 206. As yet another example, VNIC 284 is associated with compute instance 274 executed by host machine 208, and VNIC 284 is executed by NVD 212 connected to host machine 208.

For compute instances hosted by a host machine, an NVD connected to that host machine also executes VCN VRs corresponding to VCNs of which the compute instances are members. For example, in the embodiment depicted in FIG. 2, NVD 210 executes VCN VR 277 corresponding to the VCN of which compute instance 268 is a member. NVD 212 may also execute one or more VCN VRs 283 corresponding to VCNs corresponding to the compute instances hosted by host machines 206 and 208.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 2, host machine 202 is connected to NVD 210 using link 220 that extends between a port 234 provided by a NIC 232 of host machine 202 and between a port 236 of NVD 210. Host machine 206 is connected to NVD 212 using link 224 that extends between a port 246 provided by a NIC 244 of host machine 206 and between a port 248 of NVD 212. Host machine 208 is connected to NVD 212 using link 226 that extends between a port 252 provided by a NIC 250 of host machine 208 and between a port 254 of NVD 212.

The NVDs are in turn connected via communication links to top-of-the-rack (TOR) switches, which are connected to physical network 218 (also referred to as the switch fabric). In certain embodiments, the links between a host machine and an NVD, and between an NVD and a TOR switch are Ethernet links. For example, in FIG. 2, NVDs 210 and 212 are connected to TOR switches 214 and 216, respectively, using links 228 and 230. In certain embodiments, the links 220, 224, 226, 228, and 230 are Ethernet links. The collection of host machines and NVDs that are connected to a TOR is sometimes referred to as a rack.

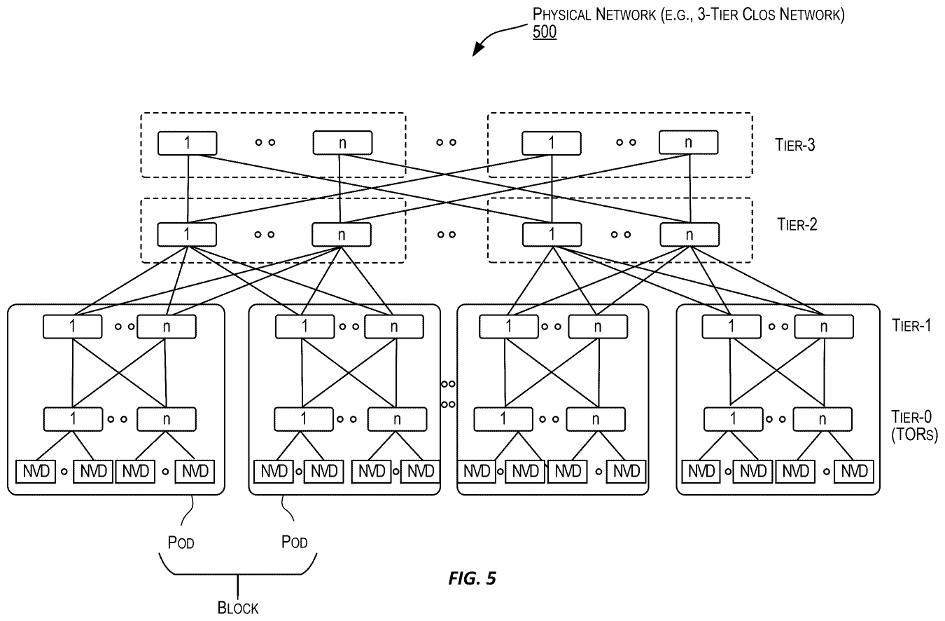

Physical network 218 provides a communication fabric that enables TOR switches to communicate with each other. Physical network 218 can be a multi-tiered network. In certain implementations, physical network 218 is a multi-tiered Clos network of switches, with TOR switches 214 and 216 representing the leaf level nodes of the multi-tiered and multi-node physical switching network 218. Different Clos network configurations are possible including but not limited to a 2-tier network, a 3-tier network, a 4-tier network, a 5-tier network, and in general a “n”-tiered network. An example of a Clos network is depicted in FIG. 5 and described below.

Various different connection configurations are possible between host machines and NVDs such as one-to-one configuration, many-to-one configuration, one-to-many configuration, and others. In a one-to-one configuration implementation, each host machine is connected to its own separate NVD. For example, in FIG. 2, host machine 202 is connected to NVD 210 via NIC 232 of host machine 202. In a many-to-one configuration, multiple host machines are connected to one NVD. For example, in FIG. 2, host machines 206 and 208 are connected to the same NVD 212 via NICs 244 and 250, respectively.

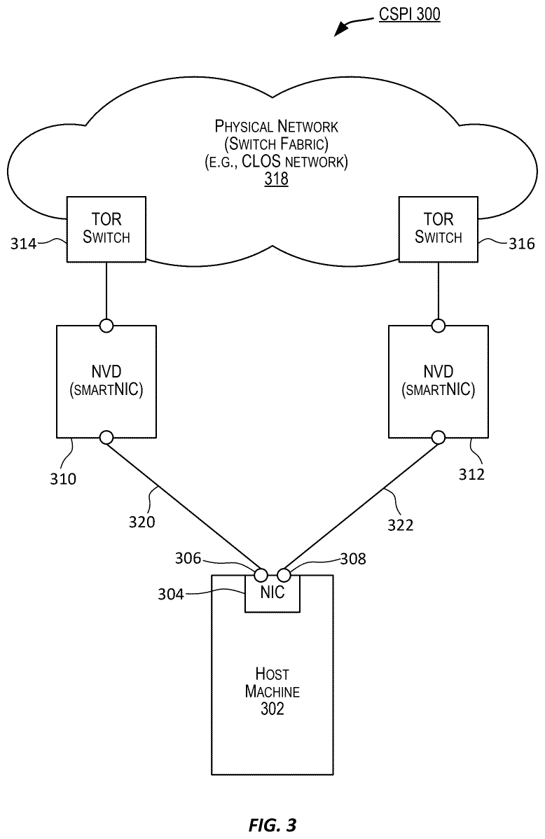

In a one-to-many configuration, one host machine is connected to multiple NVDs. FIG. 3 shows an example within CSPI 300 where a host machine is connected to multiple NVDs. As shown in FIG. 3, host machine 302 comprises a network interface card (NIC) 304 that includes multiple ports 306 and 308. Host machine 300 is connected to a first NVD 310 via port 306 and link 320, and connected to a second NVD 312 via port 308 and link 322. Ports 306 and 308 may be Ethernet ports and the links 320 and 322 between host machine 302 and NVDs 310 and 312 may be Ethernet links. NVD 310 is in turn connected to a first TOR switch 314 and NVD 312 is connected to a second TOR switch 316. The links between NVDs 310 and 312, and TOR switches 314 and 316 may be Ethernet links. TOR switches 314 and 316 represent the Tier-0 switching devices in multi-tiered physical network 318.

The arrangement depicted in FIG. 3 provides two separate physical network paths to and from physical switch network 318 to host machine 302: a first path traversing TOR switch 314 to NVD 310 to host machine 302, and a second path traversing TOR switch 316 to NVD 312 to host machine 302. The separate paths provide for enhanced availability (referred to as high availability) of host machine 302. If there are problems in one of the paths (e.g., a link in one of the paths goes down) or devices (e.g., a particular NVD is not functioning), then the other path may be used for communications to/from host machine 302.

In the configuration depicted in FIG. 3, the host machine is connected to two different NVDs using two different ports provided by a NIC of the host machine. In other embodiments, a host machine may include multiple NICs that enable connectivity of the host machine to multiple NVDs.

Referring back to FIG. 2, an NVD is a physical device or component that performs one or more network and/or storage virtualization functions. An NVD may be any device with one or more processing units (e.g., CPUs, Network Processing Units (NPUs), FPGAs, packet processing pipelines, etc.), memory including cache, and ports. The various virtualization functions may be performed by software/firmware executed by the one or more processing units of the NVD.

An NVD may be implemented in various different forms. For example, in certain embodiments, an NVD is implemented as an interface card referred to as a smartNIC or an intelligent NIC with an embedded processor onboard. A smartNIC is a separate device from the NICs on the host machines. In FIG. 2, the NVDs 210 and 212 may be implemented as smartNICs that are connected to host machines 202, and host machines 206 and 208, respectively.

A smartNIC is however just one example of an NVD implementation. Various other implementations are possible. For example, in some other implementations, an NVD or one or more functions performed by the NVD may be incorporated into or performed by one or more host machines, one or more TOR switches, and other components of CSPI 200. For example, an NVD may be embodied in a host machine where the functions performed by an NVD are performed by the host machine. As another example, an NVD may be part of a TOR switch or a TOR switch may be configured to perform functions performed by an NVD that enables the TOR switch to perform various complex packet transformations that are used for a public cloud. A TOR that performs the functions of an NVD is sometimes referred to as a smart TOR. In yet other implementations, where virtual machines (VMs) instances, but not bare metal (BM) instances, are offered to customers, functions performed by an NVD may be implemented inside a hypervisor of the host machine. In some other implementations, some of the functions of the NVD may be offloaded to a centralized service running on a fleet of host machines.

In certain embodiments, such as when implemented as a smartNIC as shown in FIG. 2, an NVD may comprise multiple physical ports that enable it to be connected to one or more host machines and to one or more TOR switches. A port on an NVD can be classified as a host-facing port (also referred to as a “south port”) or a network-facing or TOR-facing port (also referred to as a “north port”). A host-facing port of an NVD is a port that is used to connect the NVD to a host machine. Examples of host-facing ports in FIG. 2 include port 236 on NVD 210, and ports 248 and 254 on NVD 212. A network-facing port of an NVD is a port that is used to connect the NVD to a TOR switch. Examples of network-facing ports in FIG. 2 include port 256 on NVD 210, and port 258 on NVD 212. As shown in FIG. 2, NVD 210 is connected to TOR switch 214 using link 228 that extends from port 256 of NVD 210 to the TOR switch 214. Likewise, NVD 212 is connected to TOR switch 216 using link 230 that extends from port 258 of NVD 212 to the TOR switch 216.

An NVD receives packets and frames from a host machine (e.g., packets and frames generated by a compute instance hosted by the host machine) via a host-facing port and, after performing the necessary packet processing, may forward the packets and frames to a TOR switch via a network-facing port of the NVD. An NVD may receive packets and frames from a TOR switch via a network-facing port of the NVD and, after performing the necessary packet processing, may forward the packets and frames to a host machine via a host-facing port of the NVD.

In certain embodiments, there may be multiple ports and associated links between an NVD and a TOR switch. These ports and links may be aggregated to form a link aggregator group of multiple ports or links (referred to as a LAG). Link aggregation allows multiple physical links between two end-points (e.g., between an NVD and a TOR switch) to be treated as a single logical link. All the physical links in a given LAG may operate in full-duplex mode at the same speed. LAGs help increase the bandwidth and reliability of the connection between two endpoints. If one of the physical links in the LAG goes down, traffic is dynamically and transparently reassigned to one of the other physical links in the LAG. The aggregated physical links deliver higher bandwidth than each individual link. The multiple ports associated with a LAG are treated as a single logical port. Traffic can be load-balanced across the multiple physical links of a LAG. One or more LAGs may be configured between two endpoints. The two endpoints may be between an NVD and a TOR switch, between a host machine and an NVD, and the like.

An NVD implements or performs network virtualization functions. These functions are performed by software/firmware executed by the NVD. Examples of network virtualization functions include without limitation: packet encapsulation and de-capsulation functions; functions for creating a VCN network; functions for implementing network policies such as VCN security list (firewall) functionality; functions that facilitate the routing and forwarding of packets to and from compute instances in a VCN; and the like. In certain embodiments, upon receiving a packet, an NVD is configured to execute a packet processing pipeline for processing the packet and determining how the packet is to be forwarded or routed. As part of this packet processing pipeline, the NVD may execute one or more virtual functions associated with the overlay network such as executing VNICs associated with compute instances in the VCN, executing a Virtual Router (VR) associated with the VCN, the encapsulation and decapsulation of packets to facilitate forwarding or routing in the virtual network, execution of certain gateways (e.g., the Local Peering Gateway), the implementation of Security Lists, Network Security Groups, network address translation (NAT) functionality (e.g., the translation of Public IP to Private IP on a host by host basis), throttling functions, and other functions.

In certain embodiments, the packet processing data path in an NVD may comprise multiple packet pipelines, each composed of a series of packet transformation stages. In certain implementations, upon receiving a packet, the packet is parsed and classified to a single pipeline. The packet is then processed in a linear fashion, one stage after another, until the packet is either dropped or sent out over an interface of the NVD. These stages provide basic functional packet processing building blocks (e.g., validating headers, enforcing throttle, inserting new Layer-2 headers, enforcing L4 firewall, VCN encapsulation/decapsulation, etc.) so that new pipelines can be constructed by composing existing stages, and new functionality can be added by creating new stages and inserting them into existing pipelines.

An NVD may perform both control plane and data plane functions corresponding to a control plane and a data plane of a VCN. Examples of a VCN Control Plane are also depicted in FIGS. 11, 12, 13, and 14 (see references 1116, 1216, 1316, and 1416) and described below. Examples of a VCN Data Plane are depicted in FIGS. 11, 12, 13, and 14 (see references 1118, 1218, 1318, and 1418) and described below. The control plane functions include functions used for configuring a network (e.g., setting up routes and route tables, configuring VNICs, etc.) that controls how data is to be forwarded. In certain embodiments, a VCN Control Plane is provided that computes all the overlay-to-substrate mappings centrally and publishes them to the NVDs and to the virtual network edge devices such as various gateways such as the DRG, the SGW, the IGW, etc. Firewall rules may also be published using the same mechanism. In certain embodiments, an NVD only gets the mappings that are relevant for that NVD. The data plane functions include functions for the actual routing/forwarding of a packet based upon configuration set up using control plane. A VCN data plane is implemented by encapsulating the customer's network packets before they traverse the substrate network. The encapsulation/decapsulation functionality is implemented on the NVDs. In certain embodiments, an NVD is configured to intercept all network packets in and out of host machines and perform network virtualization functions.

As indicated above, an NVD executes various virtualization functions including VNICs and VCN VRs. An NVD may execute VNICs associated with the compute instances hosted by one or more host machines connected to the VNIC. For example, as depicted in FIG. 2, NVD 210 executes the functionality for VNIC 276 that is associated with compute instance 268 hosted by host machine 202 connected to NVD 210. As another example, NVD 212 executes VNIC 280 that is associated with bare metal compute instance 272 hosted by host machine 206, and executes VNIC 284 that is associated with compute instance 274 hosted by host machine 208. A host machine may host compute instances belonging to different VCNs, which belong to different customers, and the NVD connected to the host machine may execute the VNICs (i.e., execute VNICs-relate functionality) corresponding to the compute instances.

An NVD also executes VCN Virtual Routers corresponding to the VCNs of the compute instances. For example, in the embodiment depicted in FIG. 2, NVD 210 executes VCN VR 277 corresponding to the VCN to which compute instance 268 belongs. NVD 212 executes one or more VCN VRs 283 corresponding to one or more VCNs to which compute instances hosted by host machines 206 and 208 belong. In certain embodiments, the VCN VR corresponding to that VCN is executed by all the NVDs connected to host machines that host at least one compute instance belonging to that VCN. If a host machine hosts compute instances belonging to different VCNs, an NVD connected to that host machine may execute VCN VRs corresponding to those different VCNs.

In addition to VNICs and VCN VRs, an NVD may execute various software (e.g., daemons) and include one or more hardware components that facilitate the various network virtualization functions performed by the NVD. For purposes of simplicity, these various components are grouped together as “packet processing components” shown in FIG. 2. For example, NVD 210 comprises packet processing components 286 and NVD 212 comprises packet processing components 288. For example, the packet processing components for an NVD may include a packet processor that is configured to interact with the NVD's ports and hardware interfaces to monitor all packets received by and communicated using the NVD and store network information. The network information may, for example, include network flow information identifying different network flows handled by the NVD and per flow information (e.g., per flow statistics). In certain embodiments, network flows information may be stored on a per VNIC basis. The packet processor may perform packet-by-packet manipulations as well as implement stateful NAT and L4 firewall (FW). As another example, the packet processing components may include a replication agent that is configured to replicate information stored by the NVD to one or more different replication target stores. As yet another example, the packet processing components may include a logging agent that is configured to perform logging functions for the NVD. The packet processing components may also include software for monitoring the performance and health of the NVD and, also possibly of monitoring the state and health of other components connected to the NVD.

FIG. 1 shows the components of an example virtual or overlay network including a VCN, subnets within the VCN, compute instances deployed on subnets, VNICs associated with the compute instances, a VR for a VCN, and a set of gateways configured for the VCN. The overlay components depicted in FIG. 1 may be executed or hosted by one or more of the physical components depicted in FIG. 2. For example, the compute instances in a VCN may be executed or hosted by one or more host machines depicted in FIG. 2. For a compute instance hosted by a host machine, the VNIC associated with that compute instance is typically executed by an NVD connected to that host machine (i.e., the VNIC functionality is provided by the NVD connected to that host machine). The VCN VR function for a VCN is executed by all the NVDs that are connected to host machines hosting or executing the compute instances that are part of that VCN. The gateways associated with a VCN may be executed by one or more different types of NVDs. For example, certain gateways may be executed by smartNICs, while others may be executed by one or more host machines or other implementations of NVDs.

As described above, a compute instance in a customer VCN may communicate with various different endpoints, where the endpoints can be within the same subnet as the source compute instance, in a different subnet but within the same VCN as the source compute instance, or with an endpoint that is outside the VCN of the source compute instance. These communications are facilitated using VNICs associated with the compute instances, the VCN VRs, and the gateways associated with the VCNs.

For communications between two compute instances on the same subnet in a VCN, the communication is facilitated using VNICs associated with the source and destination compute instances. The source and destination compute instances may be hosted by the same host machine or by different host machines. A packet originating from a source compute instance may be forwarded from a host machine hosting the source compute instance to an NVD connected to that host machine. On the NVD, the packet is processed using a packet processing pipeline, which can include execution of the VNIC associated with the source compute instance. Since the destination endpoint for the packet is within the same subnet, execution of the VNIC associated with the source compute instance results in the packet being forwarded to an NVD executing the VNIC associated with the destination compute instance, which then processes and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs). The VNICs may use routing/forwarding tables stored by the NVD to determine the next hop for the packet.

For a packet to be communicated from a compute instance in a subnet to an endpoint in a different subnet in the same VCN, the packet originating from the source compute instance is communicated from the host machine hosting the source compute instance to the NVD connected to that host machine. On the NVD, the packet is processed using a packet processing pipeline, which can include execution of one or more VNICs, and the VR associated with the VCN. For example, as part of the packet processing pipeline, the NVD executes or invokes functionality corresponding to the VNIC (also referred to as executes the VNIC) associated with source compute instance. The functionality performed by the VNIC may include looking at the VLAN tag on the packet. Since the packet's destination is outside the subnet, the VCN VR functionality is next invoked and executed by the NVD. The VCN VR then routes the packet to the NVD executing the VNIC associated with the destination compute instance. The VNIC associated with the destination compute instance then processes the packet and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs).

If the destination for the packet is outside the VCN of the source compute instance, then the packet originating from the source compute instance is communicated from the host machine hosting the source compute instance to the NVD connected to that host machine. The NVD executes the VNIC associated with the source compute instance. Since the destination end point of the packet is outside the VCN, the packet is then processed by the VCN VR for that VCN. The NVD invokes the VCN VR functionality, which may result in the packet being forwarded to an NVD executing the appropriate gateway associated with the VCN. For example, if the destination is an endpoint within the customer's on-premise network, then the packet may be forwarded by the VCN VR to the NVD executing the DRG gateway configured for the VCN. The VCN VR may be executed on the same NVD as the NVD executing the VNIC associated with the source compute instance or by a different NVD. The gateway may be executed by an NVD, which may be a smartNIC, a host machine, or other NVD implementation. The packet is then processed by the gateway and forwarded to a next hop that facilitates communication of the packet to its intended destination endpoint. For example, in the embodiment depicted in FIG. 2, a packet originating from compute instance 268 may be communicated from host machine 202 to NVD 210 over link 220 (using NIC 232). On NVD 210, VNIC 276 is invoked since it is the VNIC associated with source compute instance 268. VNIC 276 is configured to examine the encapsulated information in the packet, and determine a next hop for forwarding the packet with the goal of facilitating communication of the packet to its intended destination endpoint, and then forward the packet to the determined next hop.

A compute instance deployed on a VCN can communicate with various different endpoints. These endpoints may include endpoints that are hosted by CSPI 200 and endpoints outside CSPI 200. Endpoints hosted by CSPI 200 may include instances in the same VCN or other VCNs, which may be the customer's VCNs, or VCNs not belonging to the customer. Communications between endpoints hosted by CSPI 200 may be performed over physical network 218. A compute instance may also communicate with endpoints that are not hosted by CSPI 200, or are outside CSPI 200. Examples of these endpoints include endpoints within a customer's on-premise network or data center, or public endpoints accessible over a public network such as the Internet. Communications with endpoints outside CSPI 200 may be performed over public networks (e.g., the Internet) (not shown in FIG. 2) or private networks (not shown in FIG. 2) using various communication protocols.

The architecture of CSPI 200 depicted in FIG. 2 is merely an example and is not intended to be limiting. Variations, alternatives, and modifications are possible in alternative embodiments. For example, in some implementations, CSPI 200 may have more or fewer systems or components than those shown in FIG. 2, may combine two or more systems, or may have a different configuration or arrangement of systems. The systems, subsystems, and other components depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

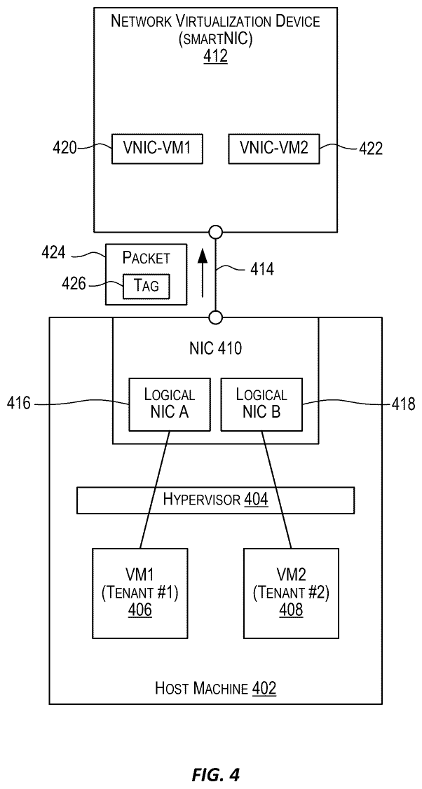

FIG. 4 depicts connectivity between a host machine and an NVD for providing I/O virtualization for supporting multitenancy according to certain embodiments. As depicted in FIG. 4, host machine 402 executes a hypervisor 404 that provides a virtualized environment. Host machine 402 executes two virtual machine instances, VM1 406 belonging to customer/tenant #1 and VM2 408 belonging to customer/tenant #2. Host machine 402 comprises a physical NIC 410 that is connected to an NVD 412 via link 414. Each of the compute instances is attached to a VNIC that is executed by NVD 412. In the embodiment in FIG. 4, VM1 406 is attached to VNIC-VM1 420 and VM2 408 is attached to VNIC-VM2 422.

As shown in FIG. 4, NIC 410 comprises two logical NICs, logical NIC A 416 and logical NIC B 418. Each virtual machine is attached to and configured to work with its own logical NIC. For example, VM1 406 is attached to logical NIC A 416 and VM2 408 is attached to logical NIC B 418. Even though host machine 402 comprises only one physical NIC 410 that is shared by the multiple tenants, due to the logical NICs, each tenant's virtual machine believes they have their own host machine and NIC.

In certain embodiments, each logical NIC is assigned its own VLAN ID. Thus, a specific VLAN ID is assigned to logical NIC A 416 for Tenant #1 and a separate VLAN ID is assigned to logical NIC B 418 for Tenant #2. When a packet is communicated from VM1 406, a tag assigned to Tenant #1 is attached to the packet by the hypervisor and the packet is then communicated from host machine 402 to NVD 412 over link 414. In a similar manner, when a packet is communicated from VM2 408, a tag assigned to Tenant #2 is attached to the packet by the hypervisor and the packet is then communicated from host machine 402 to NVD 412 over link 414. Accordingly, a packet 424 communicated from host machine 402 to NVD 412 has an associated tag 426 that identifies a specific tenant and associated VM. On the NVD, for a packet 424 received from host machine 402, the tag 426 associated with the packet is used to determine whether the packet is to be processed by VNIC-VM1 420 or by VNIC-VM2 422. The packet is then processed by the corresponding VNIC. The configuration depicted in FIG. 4 enables each tenant's compute instance to believe that they own their own host machine and NIC. The setup depicted in FIG. 4 provides for I/O virtualization for supporting multi-tenancy.

FIG. 5 depicts a simplified block diagram of a physical network 500 according to certain embodiments. The embodiment depicted in FIG. 5 is structured as a Clos network. A Clos network is a particular type of network topology designed to provide connection redundancy while maintaining high bisection bandwidth and maximum resource utilization. A Clos network is a type of non-blocking, multistage or multi-tiered switching network, where the number of stages or tiers can be two, three, four, five, etc. The embodiment depicted in FIG. 5 is a 3-tiered network comprising tiers 1, 2, and 3. The TOR switches 504 represent Tier-0 switches in the Clos network. One or more NVDs are connected to the TOR switches. Tier-0 switches are also referred to as edge devices of the physical network. The Tier-0 switches are connected to Tier-1 switches, which are also referred to as leaf switches. In the embodiment depicted in FIG. 5, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology.

The Tier-2 switches are in turn connected to “n” Tier-3 switches (sometimes referred to as super-spine switches). Communication of packets over physical network 500 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0-switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
ocid1.<RESOURCE TYPE>.<REALM>.[REGION][.FUTURE USE].<UNIQUE ID>
   where,
ocid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

### Processing Network Flows Using Flow Affinity/Locality (Colocation)

As described above, there are situations where, after the slow path plane has already programmed the accelerated path plane to handle data plane related processing for a traffic flow, there are certain actions or functions that the slow path plane has to perform for that flow. For example, the slow path plane may perform certain control plane-related actions. Examples of such actions include without limitation performing logging for a flow (also referred to as flow logging), deleting a flow when the flow expires (also referred to as flow aging or flow deletion)), and the like. As additional examples, in some situations, the accelerated path plane may be unable to perform some of its actions or functions and the slow path plane may then have to take over one or all functions performed by the accelerated path plane. This may happen, for example, when the accelerated path plane is shut down or not operational due to the presence of software or hardware problems, or when the accelerated path plane is shut down for performing a software/hardware upgrade, etc.

In such situations, when the slow path plane has to perform an action for a flow whose data plane-related processing is otherwise handled by the accelerated path plane, it is preferable that the processing be performed by the same particular core of the slow path plane that previously performed processing for the traffic flow. For example, if a particular processing component or unit (e.g., a core) of the slow path plane was selected for handling the first packet received for the flow and for programming the accelerated path plane for that flow, it is desirable that the same component or unit be selected for performing subsequent processing related to that flow. This is so that the flow colocation information can be leveraged for faster processing. The particular core may have built and cached flow-related data structures that were used by the core to process previous packets related to the flow, such as the first received packet for the flow. These data structures may still persist in the one or more caches associated with that core. These data structures may store state information for the flow such as timeout data, statistical data about the flow, routing information, n-tuple hash information, etc. Accordingly, if the same core performs the subsequent processing, the core can reuse and take advantage of these already built, cached, and available data structures and flow state information. If instead, the processing was performed by some other core of the slow path plane, that other core would have to rebuild these data structures in order to perform the processing. This rebuilding of the data structure can take time and thus add unwanted latency to the processing making the processing slower. Accordingly, it is preferable that the processing for a traffic flow be performed by the same core of the slow path plane so that the core can leverage the data structures stored in its cache(s) and be able to perform the flow-related processing in a faster manner with reduced latency. Also, all these data structures are not thread-safe and give higher performance.

The present disclosure describes improved packet and flow processing techniques implemented in a network device that includes at least two different processing planes for processing packet flows and associated packets, where the improved techniques take advantage of network flow affinity/locality for faster packet flows-related processing. In certain implementations, the techniques described herein can be implemented in a network virtualization device (NVD), such as in a smartNIC that is configured to perform network virtualization functions.

FIG. 6 is a simplified block diagram of an example network device 600 that may implement one or more of the innovative techniques described in this disclosure. In the embodiment depicted in FIG. 6, network device 600 is an NVD. In certain implementations, the NVD may be in the form of a smartNIC. As shown in FIG. 6, NVD 600 may include one or more ports 602. NVD 600 may receive packets and transmit packets using one or more ports 602. A port on which a packet is received by NVD 600 is sometimes referred to as an ingress port. A port that is used to transmit a packet from NVD 600 is sometimes referred to as an egress port. The same port may function as an ingress port and an egress port. In certain implementations, ports 602 may include Ethernet ports. In certain implementations, when a packet is received by NVD 600 on an ingress port, the packet is stored in a packet buffer 608. The packet may then be processed by one of the multiple processing planes provided by NVD 600.

In the embodiment depicted in FIG. 6, NVD 600 comprises two processing planes, namely, an accelerated processing path plane 604 (referred to as accelerated path plane 604) and a slow path processing plane 606 (referred to as slow path plane 606). Each processing plane may comprise one or more processing units or components. Typically, the processing units of one processing plane are able to perform certain operations faster than the processing units of the second processing plane. For example, in the embodiment depicted in FIG. 6, the processing units of accelerated path plane 604 are able to perform certain operations faster than the processing units of slow path plane 606.

In the example depicted in FIG. 6, slow path plane 606 comprises multiple cores (e.g., ARM cores) 618, with each core having its associated cache 620. A cache 620 associated with a core 618 can include one or more levels (e.g., L1, L2, etc.) of cache. A cache associated with a core is referred to as being local to the core. A cache 620 associated with a core 618 may store information, including one or more data structures storing flow state information, which is used by the core to process packets. The data structures may store state information for the flow such as timeout data, statistical data about the flow, routing information, n-tuple hash information, etc.

In the embodiment depicted in FIG. 6, accelerated path plane 604 comprises MPUs and/or ASICs 614. A cache 616 is associated with and shared by MPUs and/or ASICs 614. Cache 616 may store information, including one or more data structures, which is used by the MPUs and/or ASICs 614 to process packets. In other embodiments, each MPU 614 may have its own separate cache. MPUs and/or ASICs 614 can run P4 code for performing various network functions (e.g., encapsulation of packets, decapsulation of packets). As previously indicated, P4 is a programming language that is typically used for performing packet processing functions in forwarding planes in networking devices. In contrast to general purpose languages such as C or Python, P4 is a domain-specific language with a number of constructs optimized for network data forwarding. The accelerated path plane 604 can thus process packets faster than the slow path plane. In certain implementations, accelerated path plane 604 can process 40 million PPS (packets per second), while slow path plane 606 comprising the ARM cores can do about 10 million PPS. The MPUs and/or ASICs 614 can be organized into groups of MPUs and/or ASICs and different pipelines of MPUs and/or ASICs. MPUs and/or ASICs 614 can run multiple stages and a packet could be processed by multiple MPUs and/or ASICs. There could be a pipeline of actions performed by multiple MPUs and/or ASICs.

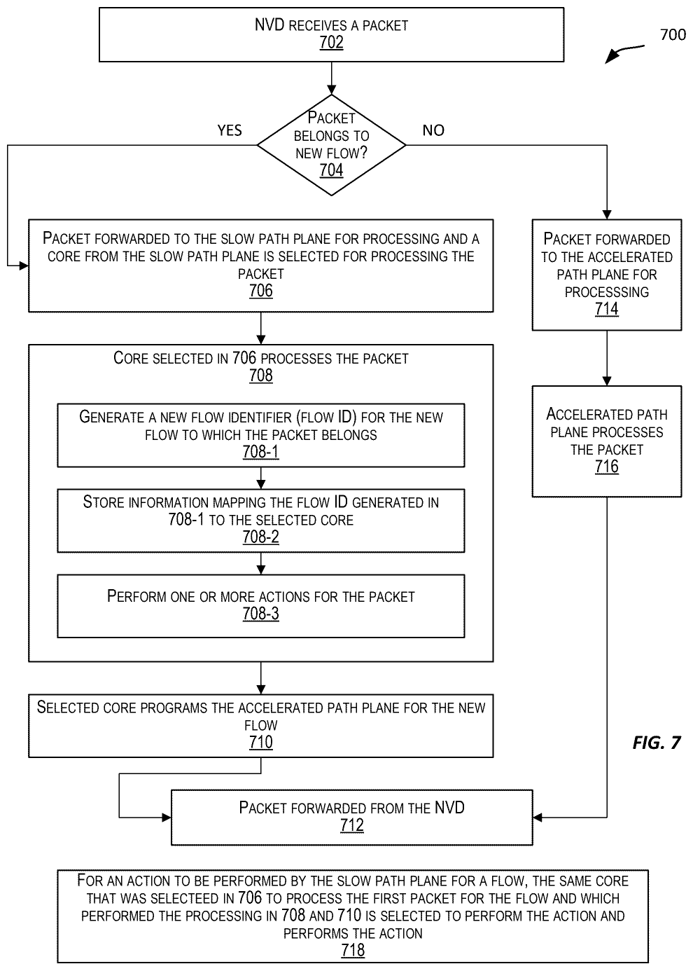

As shown in FIG. 6, NVD 600 can also include a shared memory 610 that is shared between accelerated path plane 604 and slow path plane 606. NVD 600 can also include one or more additional memories, such as DRAM 612. Databus/Interconnect 613 provides interconnectivity between the various components of NVD 600. The functions performed by the various components of NVD 600 are further described below with respect to flowchart 700 depicted in FIG. 7.

FIG. 7 depicts a simplified flowchart 700 showing processing performed by an NVD (or a network device, in general) upon receiving a packet for a new flow according to certain embodiments. The processing depicted in FIG. 7 and described below may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method depicted in FIG. 7 and described below is intended to be illustrative and non-limiting. Although the various processing steps are shown as occurring in a particular sequence or order, this is not intended to be limiting. In certain alternative embodiments, the processing may be performed in some different order, or some steps may also be performed in parallel. The processing depicted in FIG. 7 has been explained in reference to NVD 600 depicted in FIG. 6.

At 702, NVD 600 receives a packet. The packet may be received, for example, via a port 602 (e.g., Ethernet port) of NVD 600. The received packet may be placed in a memory that is shared by the accelerated path plane and the slow path plane, such as in a packet buffer 608 (or DRAM 612) of NVD 600. In some embodiments, the packet buffer 608 itself may include one or more memories (e.g., dynamic random-access memory (DRAM), static random-access memory (SRAM), etc.). In certain implementations, packet buffer 220 may queue received packets for further processing by slow path plane 606 or accelerated path plane 604.

At 704, processing is performed to determine whether the packet belongs to a flow that accelerated path plane 604 is already programmed to handle (i.e., the received packet is not the first packet received by the NVD 600 for the flow), or whether the packet is the first packet for a new flow for which the accelerated path plane 604 has not yet been programmed to handle. In certain implementations, a set of rules are applied to perform the processing in 704. Upon determining in 704 that the received packet belongs to a new flow, then processing continues with 706. Upon determining in 704 that the received packet belongs to an existing flow that the accelerated path plane has already been programmed to handle, then processing continues with 714.

Various different techniques may be used to determine the flow to which the packet belongs. For example, the 5-tuple (or 6-tuple) information extracted from the header of the received packet may be used to determine a flow for the packet. In certain implementations, packets belonging to the same flow must have the same 5-tuple (or 6-tuple) pieces of information.

At 706, upon determining that the packet is for a new flow (i.e., is the first packet received by the NVD for the flow), the packet is sent to the slow path plane 606 for processing and a core 618 from the multiple cores of the slow path plane 606 is selected for processing the packet.

In certain implementations, the processing in 704 is performed by the accelerated path plane 604. For example, the accelerated path plane 604 may be “sitting on the wire” and looks at each packet received by the NVD 600 and determines whether it knows what to do with the packet (i.e., whether accelerated path plane 604 has previously been programmed by the slow path plane 606 for that flow). If the accelerated path plane 604 does not know how to process the packet, the accelerated path plane 604 sends the packet to the slow path plane 606 for processing. In certain implementations, as part of this processing, the accelerated path plane 604 may write the packet to shared memory 610, which is shared between the accelerated path plane 604 and the slow path plane 606. In certain other embodiments, the slow path plane 606 may pick the packet up from packet buffer 608. In certain use cases, in about 99% of the cases, the accelerated path plane 604 knows how to process received packets and the packet never gets sent to the slow path plane 606.

As indicated above, a particular core of the slow path plane 606 is selected in 706 for processing the received packet. Various different techniques may be used for selecting a particular core of the slow path plane 606 for processing the packet from the multiple available cores of the slow path plane 606. In certain implementations, an RSS hashing technique is used to select the core in 706. For example, the 6-tuple or the 5-tuple information determined from the header (e.g., encapsulated header) of the received packet may be hashed to generate a hash value. The hash value may then be used to select a core from the slow path plane to process the packet. For example, in an NVD with a slow path plane comprising sixteen (16) ARM cores, a 16-bit RSS hashing technique may be used to hash the 5-tuple or 6-tuple extracted from the packet header to generate a hash value. The generated hash value may then be used to select a particular ARM core 618 from the sixteen cores in the slow path plane. In certain implementations, the selected core may receive an interrupt, and in response, the packet may be copied (e.g., using Direct Memory Access (DMA) techniques) from the packet buffer 608 to a cache 620 associated with the selected core 618.

In alternative embodiments other hashing techniques may be used. Further, while the various examples described in this disclosure use a 5-tuple or a 6-tuple for the hashing and flow identification, this is not intended to be limiting. In alternative embodiments, other tuples using more or fewer than 5 or 6 fields of the packet header may be used for hashing and for flow identification.

At 708, the core 618 selected in 706 performs processing for the packet. As part of the processing, the selected core may:
(a) At 708-1, the selected core may generate a new identifier (flow ID) for the new flow.
(b) At 708-2, the selected core may store information mapping the new flow identifier generated in 708-1 to the selected core. In certain implementations, the information mapping the core to the flow (e.g., the flow ID generated in 708-1) may be stored as part to flow ID-to-cores mapping information 626 in shared memory 610 of NVD 600. The selected core may be identified using a core identifier (core ID). Accordingly, a mapping between the flow and the core may be stored as a mapping between a flow ID and a core ID, such as (flow ID: core ID). For example, “Flow X: Core Y” may indicate that flow X is mapped to core Y (or core Y is mapped to Flow X) thereby indicating that the processing of the first packet for traffic flow identified by “Flow X” was handled by the core identified by “Core Y” identifier. The mapping information may be stored in shared memory 610 from where it can be accessed by both components of accelerated path plane 604 and slow path plane 606. As described below, the flow ID-to-cores mapping information 626 is used to identify the specific selected for processing that is to be performed by slow path plane 606 after the accelerated path plane 604 has been programmed to process the flow. In some embodiments, in addition to the flow IDs-to-cores mapping information or instead of the flow IDs-to-cores mapping information, each core may store a list of flows for which the first packets for the flows were processed by the core. In certain implementations, a core may store this list in a memory accessible to the core, such as in a cache associated with the core.
(c) At 708-3, the selected core 618 performs one or more actions for the packet, such as encapsulation/decapsulation actions, etc.

As part of the processing performed in 708, the core from the slow path plane 606 that processes the packet may build one or more data structures in its associated cache to facilitate the processing of the packet. The one or more data structures may store flow state information for the flow corresponding to the packet. One or more cache entries may be stored in the core's cache storing information used for processing the packet for the new network flow. For example, the cache may store a hash table data structure, data structures storing information regarding the 5-tuple or 6-tuple of the received packet, and other packet or associated flow-related information. The packet itself may contain any suitable payload contents (e.g., text video, audio, etc.) associated with a particular flow between the endpoints.

At 710, the selected core programs the accelerated path plane 604 for the new flow. This enables the processing of subsequent packets belonging to the flow to be handled by the accelerated path plane 604 instead of the slow path plane 606. The programming enables the accelerated path plane 604, instead of slow path plane 606, to perform data plane related functions for subsequent packets received by the NVD for the flow. In certain implementations, as part of the programming, information regarding the flow ID for the new flow is conveyed to the accelerated path plane 604. The information mapping flow IDs to core IDs may be stored in a location accessible to the accelerated path plane. As part of the programming, rules may be programmed that identify the flow and how packets belonging to the flow are to be processed by the accelerated path plane 604. The programmed information may include rules related to the actions to be performed for the new flow, such as related to packet encapsulation, aging, logging, etc.

In certain implementations, such as the embodiment depicted in FIG. 6, the accelerated path plane 604 and the slow path plane 606 both have access to a shared memory 610. In such an embodiment, as part of programming the accelerated path plane 604 for a flow, the selected core may write rules 622 to the shared memory 610 identifying the programmed flows and, for each flow, how packets received for that flow are to be processed by the accelerated path plane 604. The rules 622 can further include an indicator of the status of the programmed flows. These statuses can include, for example, active/valid, soft-invalidated/soft-invalid; or invalid. In some embodiments, the rules can further include an indicator of the version of the programmed flows. This indicator of the version can be in the form of an indicator of an epoch for the programmed flows such that each of the programmed flows has its own indicator of its epoch. The mapping information 626 may also be written to the shared memory 610 for access by the accelerated path plane 604.

At 712, the packet is forwarded from the NVD 600. In the case where the packet is processed by the slow path plane, the packet forwarding is done based upon processing performed by the selected core of the slow path plane and without involving the accelerated path plane. For example, the packet may be forwarded from a port 602 of NVD 600 to another network device to facilitate communication of the packet to its intended destination. For example, the packet may be forwarded from NVD 600 to another NVD associated with the host machine that is the intended recipient of the packet. The processing performed by the core of the slow path plane may identify which port of the NVD the packet is to go out on.

In certain implementations, as part of 712, the packet may be queued in packet buffer 608 waiting to be routed to another network device. In some embodiments, a traffic manager process may be provided that coordinates (e.g., including load-balancing) queueing and/or de-queueing of packets in packet buffer 608 and for facilitating forwarding of the packets from NVD 600.

If it is determined in 704 that the received packet is not the first packet for a flow (i.e., is the second or subsequent packet for the flow) but is instead a packet belonging to a known flow for which the accelerated path plane 604 has already been programmed (e.g., programmed by slow path plane 606 in 710) to handle, then, at 714, the packet is forwarded to accelerated path plane 604 for processing.

At 716, the packet is processed by the accelerated path plane 604. In certain implementations, the P4 code running on MPUs and/or ASICs 614 of accelerated path plane 604 examine the packet and determine how it is to be processed and perform the appropriate actions. Rules programmed for processing packets for that flow may be used to determine the actions to be performed. These actions may include, for example, adding a particular encapsulation to the packet, determining a port of NVD 600 to be used for egressing the packet, and other actions.

The processing in 716 may be performed by one or more MPUs and/or ASICs 614 of the accelerated path plane 604. The MPUs and/or ASICs may be organized into multiple pipelines including an ingress pipeline and an egress pipeline. The ingress pipeline may be configured to perform flow identification, encapsulate the packet, and send it to an egress pipeline where other actions (e.g., updating counters associated with the flow to which the packet belongs, update other info for the flow) may be performed after identifying the flow to which the packet belongs. Cache 616 associated with the MPUs and/or ASICs may store information and one or more data structures that are used by the MPUs and/or ASICs 614 to process the packets. Flow identification may include determining the flow ID for the flow to which the packet belongs. The egress pipeline may then forward the packet from the NVD in 712. In some cases, the packet may be forwarded from NVD 600 via a selected port to another network device for facilitating communication of the packet to its intended destination. For example, the packet may be forwarded to another NVD associated with the intended destination host for the packet. In some other use cases, the packet may get sent to one of the DMA portions of the accelerated path plane and the packet may get DMAed to the host via a PCIe interface.

After the slow path plane has processed the first packet received for a flow and programmed the accelerated path plane to handling data plane related processing for the traffic flow, there are certain actions or functions related for the traffic flow that are to be performed by the slow path plane. These actions may be referred to as slow path plane actions. In 718, for any action to be performed by the slow path plane for a flow after the first packet for the flow has been processed and the accelerated path plane programmed for that flow, the same slow path plane core that was selected in 706 for the first packet received for the flow and which performed the processing in 708 and 710 is selected to perform the action and the selected core then performs the action. Performing the action may include performing various processing corresponding to the action. In this manner, flow affinity/locality information is used to perform the action. As described below, different innovative techniques may be used in 718 to cause the action to be performed by same slow path plane core.

As indicated above, there are various actions that are performed by the slow path plane after a processing unit of the slow path plane (e.g., a processing core of the slow path plane) has already performed processing for the first packet received for the flow by the network device and programmed the accelerated path plane for handling data plane related processing for that flow. As described herein, these subsequent actions for a flow (subsequent because they are performed after the slow path plane has already processed the first packet received for the flow and programmed the accelerated path plane for handling data plane related processing for the flow) are also performed by the same processing unit of the slow path plane that processed the first packet for that flow and programmed the accelerated path plane.

There are various examples of such actions that are performed by the slow path plane including, but not limited to, actions for flow aging, for flow logging, and other actions. The following section describes actions associated with flow aging and flow logging. This is however not intended to be limiting or restricting in any manner. Flow aging and flow logging are just example of actions that are performed by the slow path plane and to which teachings described in this disclosure may be applied.

### Flow Aging

There are various scenarios that may cause a traffic flow, that the accelerated path plane has been programmed to handle, to be deleted from an NVD. As one example, this may occur when there is a reset of the system (e.g., an inline delete). The slow path plane may receive a reset signal and then a core from the slow path plane may perform processing to delete a flow.

As another example, deletion of a flow can also be caused due to aging of a flow (referred to as flow aging). After the accelerated path plane has been programmed by the slow path plane to handle packet processing for a particular network flow, as part of its processing, the accelerated path plane keeps track of packets received for the flow and the time when the packets arrive at the NVD. In certain implementations, if the next packet in the flow is not received within a certain time interval from the last received packet for the flow (i.e., the time period between two packets is not within a certain time interval threshold), the accelerated path plane marks that flow as expired or aged. For example, if a packet for a particular flow does not arrive within some threshold time (e.g., 20 secs, 30 secs) of the last received packet, the accelerated path plane deems the flow as having aged or expired.

In certain implementations, the accelerated path plane sets a flag associated with the flow indicating the flow as aged or expired. For a flow marked as aged, the slow path plane then has to perform an action responsive to the flow being marked as aged. Performance of the action may include performing one or more sub-actions such as deleting the flow entries corresponding to the expired flow, deprogramming the accelerated path plane for the flow, and the like. In certain implementations, as part of performing the action, a core from the slow path plane that handles the processing may call one or more APIs provided by the accelerated path plane to perform the action or sub-actions.

In certain implementations, the accelerated path plane may inform the slow path plane that a flow has aged or expired by sending a notification to the slow path plane that the flow has aged (flow aged notification), and a core of the slow path plane then performs the responsive action.

It is preferred that the action and the related processing that is performed by the slow path plane for a flow that is aged be performed by the same core of the slow path plane that processed a previous packet of the flow (e.g., the first received packet for the flow) and which programmed the accelerated path plane for the flow. For example, in the scenario where the accelerated path plane sends a flow aged notification to the slow path plane, it is desired that the notification be sent to that same core from the slow path plane that previously performed processing for the flow. This enables any data structures storing flow state information cached by that core when a previous packet belonging to that flow was processed by that core to be taken advantage of and used for performing processing responsive to the flow aging or deletion notification. That same core can then use the previously built and cached data structures for performing an action responsive to the flow aging notification. This enables the action for the flow to the performed in a faster time than if the processing had been performed by some other core from the slow path plane. As described below, techniques are described that enable the flow aging action to be performed by the same core that processed a previous packet of the flow (e.g., the first received packet for the flow).

### Flow Logging

Once the accelerated path plane has been programmed to handle a traffic flow, the accelerated path plane, as part of its processing for the flow, is configured to store or log information for the flow. This logged information (referred to as flow log information or flow log data) may include, for example, information related to various statistics and counters for the flow (e.g., how many packets for the flow are received by the NVD, when the packets are received including when the last packet for the flow was received), flow gaining information for the flow, and other flow-related information. For each flow handled by the accelerated path plane, the slow path plane is configured to, on a periodic basis (e.g., every 30 seconds, every minute, every 10 minutes, etc.), fetch information that is logged by the accelerated path plane for the flow. The slow path plane may then provide the fetched flow log information to a downstream consumer of the logged information (e.g., send it to the customer, send it to a downstream analytics or metrics service, send it to a logging service), store the flow log information in a database or memory, and the like. The accelerated processing plane thus manages and is responsible for logging information for each of the flows that the accelerated path plane is programmed to handle, and the slow path plane has to perform a flow logging action on a periodic basis for flow log information logged by the accelerated path plane.

In certain implementations, the accelerated path plane periodically sends a notification (referred to as a flow logging notification) to the slow path plane, for example, every minute. Upon receiving the notification, a core from the slow path plane picks up the notification and performs an action responsive to the notification where the action can include fetching the flow log data for the flow corresponding to the notification raised by the accelerated path plane, sending the fetched flow log data to some downstream consumer of the data (e.g., a metrics service, to a customer), and/or storing the fetched information in a database or other memory storage.

It is preferred that the processing related to flow logging be performed by the same core of the slow path plane that previously performed processing for the flow, such as a core that processed the first received packet for the flow and which programmed the accelerated path plane for the flow. It is thus desired that the flow logging notification sent by the accelerated path plane be sent to and be processed by this same core of the slow path plane. This enables any data structures cached by that core when a previous packet belonging to the flow was processed by that core to be taken advantage of and be used for performing processing responsive to the flow logging notification. That same core can then use these previously cached data structures for performing the flow logging related processing in a faster time than if the processing had been performed by some other core from the slow path plane. As described below, techniques are described that enable the flow logging notification to be sent to the same core that processed a previous packet of the flow (e.g., the first received packet for the flow).

In certain implementations, the flow log information written by the accelerated path plane for the various flows handled by the accelerated path plane may be written to memory in the form of one or more log entries. One or more multiple log entries may be written by the accelerated path plane for a flow. Each log entry comprises information (e.g., flow ID) identifying the flow for which the log entry is written. In certain implementations, these log entries may be written to a shared memory (e.g., shared memory 610 depicted in FIG. 6) that is shared between the accelerated path plane and the slow path plane. The cores from the slow path plane are configured to read and fetch the log entries from the shared memory and perform processing for the fetched entries. It is again preferable that, for a log entry for a particular flow, the same core of the slow path plane that previously performed processing for the flow perform the flow logging action and related processing.

### General Actions Performed by the Slow Path Plane

Flow aging and flow logging are examples of situations where actions are performed by the slow path plane for a particular flow even after the slow path plane has already programmed the accelerated path plane for handling that flow. Flow aging and flow logging are merely examples of such actions and are not intended to limit the scope of claimed embodiments. Other actions may also be performed using similar techniques.

In general, after the slow path plane has processed a first packet for a flow and programmed the accelerated path plane for that packet flow, subsequent processing related to the flow that is to be performed by the slow path plane, it is desired that the processing be performed by the same core of the slow path plane that previously processed the flow. For example, it is preferred that the action be performed by the same core that processed the first packet received by the NVD for the flow and programmed the accelerated path plane for handling data plane forwarding for the flow. The teachings described in this disclosure enable the same core to perform the processing. The teachings described herein can apply to any action that the slow path plane performs after the accelerated path plane has already been programmed by the slow path plane to handle processing for the flow.

According to certain embodiments, when a core of the slow path plane has previously performed processing for a flow, for any subsequent action to be performed by the slow path plane for that flow, the teachings described in this disclosure enable the action to be directed to and be performed by the same core of the slow path plane that previously performed processing for the flow. For example, the subsequent action is performed by the core that processed the first packet belonging to the flow that was received by the NVD and programmed the accelerated path plane for that particular flow.

### Provisional Invalidation

Provisional invalidation can improve fast path/slow path processing by preventing the immediate invalidation of a flow thereby creating a potential thundering herd problem. Specifically, after receipt of a message, such as a configuration update, leading to the provisional invalidation of a flow, provisional invalidation creates a limited time period during which packets of the provisionally invalidated flow are still processed by the fast path according to the previous programming of the fast path. Also during this time period, and in some instances, simultaneously with the fast path processing of packets according to previous programming, the slow path processes a probe packet generated by the fast path based on a received packet of the provisionally invalidated flow and reprograms the fast path based on that probe packet and any configuration updates that led to the provisional invalidation of the flow. Thus, during this period of provisional invalidation, the main burden for packet processing within the provisionally invalidated flow remains with the fast path, while the slow path is only responsible for the processing of the probe packet and the reprogramming of the fast path. This maintaining of the processing burden at the fast path prevents the overwhelming of the slow path, and thereby improves the speed, reliability, and predictability of packet processing.

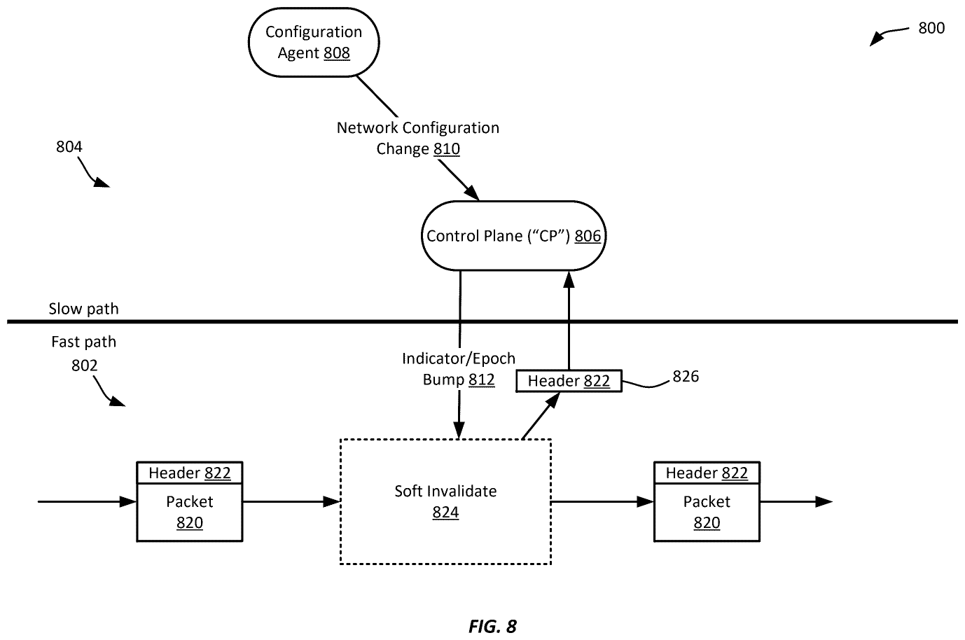

FIG. 8 is a schematic depiction of provisional invalidation 800. As seen, FIG. 8 is split, dividing the figure into a fast path section 802 representing events occurring at the fast path and/or actions taken by the fast path and a slow path section 804 representing events occurring at the slow path and/or actions taken by the slow path. As depicted in FIG. 8, the slow path can include the control plane (“CP”) 806. The CP 806 can receive configuration updates, can process packets and/or probe packets, can provide indicators to the fast path of status of one or several flows, and can program the fast path. In some embodiments, the CP 806 can comprise a software module that can be executed on hardware within the NVD 600, or elsewhere within or on one or several: computing systems; servers; processors, or the like.

As seen in FIG. 8, a configuration agent 808 can provide a network configuration change 810 to the CP 806. This configuration change 810 can change one or more aspects of handling/processing packets within a flow. This can include, for example, changing one or more: security settings; controls lists such as Access Control Lists (ACLs); routing instructions; encapsulation and/or decapsulation requirements, or the like. In some embodiments, the change of routing instructions can include changes to the destination including the destination IP address, changes to a route table associated with the flow, or the like.

Upon receiving this network configuration change, the CP 806 can identify one or several flows associated with the configuration change, and can update the status of these one or several flows to provisionally invalid. As part of this, the CP 806 can provide an indicator 812 to the fast path identifying one or several provisionally invalid flows. In some embodiments, an indicator of provisionally invalid status can be provided for each flow that was provisionally invalidated in response to receipt of the network configuration change 810. This indicator can be in the form of an epoch bump, or in other words, an indication that packets in the provisionally invalid flow should be processed according to programming of a higher epoch.

In addition to providing the indicator to the fast path, the slow path can start a timer to track the duration of the provisionally invalid state. Alternatively, in some embodiments, the fast path can start the timer upon receipt of the indicator. In some embodiments, for example, the provisionally invalid state can only occur for a limited duration of time, which duration can be tracked with the timer. In the event that the fast path is not reprogrammed within the limited duration of time for the provisionally invalid state, then the flow is invalidated and any subsequently received packets in the invalidated flow are provided to the slow path for processing. In some embodiments determining if the duration of the provisionally invalidated state has reached the maximum allowed time can include comparing the timer to one or several thresholds, and classifying the flow as invalid when the duration of time indicated by the timer exceeds the threshold. In such an instance, the CP 806 can provide another indicator 812 to the fast path changing the status of the flow from provisionally invalid to invalid.

As also indicated in FIG. 8, the fast path can receive a packet 820 for a previously programmed flow. The packet 820 can include a header 822, and in some embodiments, can include a payload. As discussed above, the header 822 can include information that, for the packet, identifies the flow to which the packet belongs, the source of the packet, the destination of the packet, IP version, time-to-live, security information, or the like. Upon receipt of the packet 820, the fast path can, based on information contained in the header 822 determine the flow of the packet 820. In some embodiments, this can include the fast path decapsulating the packet 820 and/or the header 822 and extracting information from the header identifying the associated flow. Based on the identity of the flow to which the packet 820 belongs, the fast path can determine the status of the flow. This can include, determining if an indicator of invalidity and/or provisional invalidity has been received, and specifically has been received from the CP 806, determining if the epoch of the fast path programming for the flow matches the current epoch for the flow, or the like. If it is determined that the flow is valid, then the fast path processes the packet 820 according to the fast path programming. If it is determined that the flow is invalid, then the fast path drops the packet 820. In some embodiments, the fast path dropping the packet 820 can include terminating processing of the packet 820 and providing packet 820 to the slow path for processing. In some embodiments, the packet 820 is processed by the slow path.

In some embodiments, and as shown in FIG. 8, the receipt of the indicator 812 by the fast path from the CP 806, or in other words, from the slow path, can create a soft invalidate state 824 for the flow associated with the indicator. If it is determined that the flow is provisionally invalid, the fast path can determine whether a probe packet 826 should be provided to the fast path. In some embodiments, for example, a first packet received in a flow after the soft invalidation of that flow can result in the generation of a probe packet 826 and the sending of the probe packet 826 to the slow path and/or to the CP 806. In such an embodiment, and upon receipt of a packet of a provisionally invalidated flow, the fast path can determine if a probe packet 826 has been previously provided to the slow path and/to the CP 806. If a probe packet 826 has not been previously provided, then a probe packet 826 can be generated and the probe packet 826 can be provided to the fast path.

Alternatively, in some embodiments, multiple probe packets 826 can be sent while a flow is provisionally invalidated. In such an embodiment, these rate at which these probe packets 826 are generated and sent can be limited to prevent shifting to much workload to the slow path. However, the sending of multiple packets can prevent errors arising due to loss or the initial probe packet 826. In such an embodiment, the fast path can determine if the received packet is the first packet in a flow received after provisional invalidation of the flow, and if so, the fast path can generate the probe packet 826 and can send the probe packet 826 to the slow path and/or CP 806. If the packet is not the first packet, the fast path can determine if more time than the predetermined packet interval has elapsed since the sending of the previous probe packet 826. If less time than the packet interval has elapsed since sending the previous probe packet 826, then the fast path does not generate and send a new probe packet 826. Alternatively, if more time than the packet interval has elapsed since sending the previous probe packet 826, then the fast path can generate and send a new probe packet 826 to the slow path and/or CP 806.

This interval can be a pre-defined interval, that can apply to some or all of the configuration updates. In some embodiments, this interval can be the same for some or all configuration updates, or can vary from one configuration update to another.

In some embodiments, the probe packet 826 can be generated based on the received packet, and specifically can be generated based on all or portions of the received packet. In some embodiments, the probe packet 826 can comprise a replica/copy of all or portions of the received packet. In some embodiments, the probe packet 826 can comprise a replica/copy of all or portions of the header 822, as depicted in FIG. 8.

In embodiments in which the fast path programming for the flow of the received packet is provisionally invalidated, then the received packet can be processed by the fast path according to the provisionally invalid fast path programming.

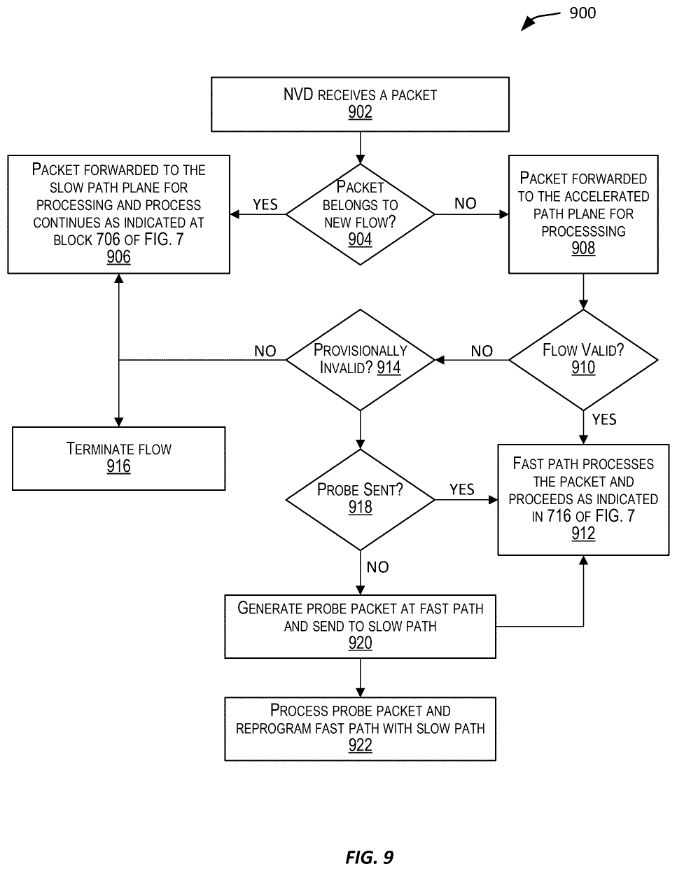

With reference now to FIG. 9, a flowchart depicting one embodiment of a process 900 for provisional invalidation is shown. The process 900 can be performed by all or portions of the NVD 600, and/or by on one or several: computing systems; servers; processors, or the like. In some embodiments, the process 900 can be performed by a plurality of NVDs and/or other processing systems, together referred to herein as a provisional invalidation system.

The process 900 begins at block 902, wherein the provisional invalidation system and/or an NVD 600 in the provisional invalidation system receives a packet. The packet may be received, for example, via a port 602 (e.g., Ethernet port) of NVD 600. In some embodiments, the received packet may be placed in a memory that is shared by the accelerated path plane and the slow path plane, such as in a packet buffer 608 (or DRAM 612) of NVD 600. In some embodiments, the packet buffer 608 itself may include one or more memories (e.g., dynamic random-access memory (DRAM), static random-access memory (SRAM), etc.). In certain implementations, packet buffer 220 may queue received packets for further processing by slow path plane 606 or accelerated path plane 604.

At 904, processing is performed to determine whether the packet belongs to a flow that accelerated path plane 604 is already programmed to handle (i.e., the received packet is not the first packet received by the NVD 600 for the flow), or whether the packet is the first packet for a new flow for which the accelerated path plane 604 has not yet been programmed to handle. In certain implementations, a set of rules are applied to perform the processing in 904. Upon determining in 904 that the received packet belongs to a new flow, then processing continues with 906 and the packet is forwarded to the slow path plane for processing and the process 900 proceeds to block 706 of FIG. 7

In certain implementations, the processing in 904 is performed by the accelerated path plane 604. For example, the accelerated path plane 604 may be “sitting on the wire” and looks at each packet received by the NVD 600 and determines whether it knows what to do with the packet (i.e., whether accelerated path plane 604 has previously been programmed by the slow path plane 606 for that flow). If the accelerated path plane 604 does not know how to process the packet, the accelerated path plane 604 sends the packet to the slow path plane 606 for processing. In certain implementations, as part of this processing, the accelerated path plane 604 may write the packet to shared memory 610, which is shared between the accelerated path plane 604 and the slow path plane 606. In certain other embodiments, the slow path plane 606 may pick the packet up from packet buffer 608. In certain use cases, in about 99% of the cases, the accelerated path plane 604 knows how to process received packets and the packet never gets sent to the slow path plane 606.

If it is determined in 904 that the received packet is not the first packet for a flow (i.e., is the second or subsequent packet for the flow) but is instead a packet belonging to a known flow for which the accelerated path plane 604 has already been programmed (e.g., programmed by slow path plane 606) to handle, then, at 908, the packet is forwarded to accelerated path plane 604 for processing.

At decision steps 910 and 914, processing is performed to determine if the flow of the received packet is valid. This includes performing processing at 910 to determine if the flow is valid or is invalid. In some embodiments, the processing can be performed by the fast path plane 604 and can include determining whether an indicator has been received from the slow path plane 606 that indicates that the flow is invalid. In some embodiments, this indicator can be received by the shared memory 610, and determining if the indicator has been received can include querying the shared memory for the indicator and/or for any indicator associated with the flow. In some embodiments, this can include determining whether an epoch bump has been received subsequent to the programming of the fast path, and whether this epoch bump indicates that the flow is invalid. If it is determined that the flow is valid, then the process 900 continues to block 912 and proceeds to block 716 of FIG. 7, wherein the fast path plane 604 processes the packet.

At decision step 914, processing is performed to determine if the invalid flow is provisionally invalid. The processing can be performed by the fast path plane 604 and can include determining whether an indicator has been received from the slow path plane 606 that indicates that the flow is provisionally invalid. In some embodiments, this indicator can be received by the shared memory 610, and determining if the indicator has been received can include querying the shared memory for the indicator and/or for any indicator associated with the flow. In some embodiments, this can include determining whether an epoch bump has been received subsequent to the programming of the fast path, and whether this epoch bump indicates that the flow is provisionally invalid. If it is determined that the flow is not provisionally invalid, and is invalid, then the process 900 proceeds to block 916 and the flow is terminated and/or the packet is dropped. In some embodiments, and as an alternative, if it is determined that the flow is invalid, the valid, then the process 900 continues to block 906 and the packet is forwarded to the slow path plane for processing and the process 900 proceeds to block 706 of FIG. 7.

Returning to decision step 914, if it is determined that the flow is provisionally invalid, then the process 900 proceeds to decision step 918, wherein processing is performed to determine if the probe packet 826 has been sent. In some embodiments, and as discussed above, this can include determining if a probe packet 826 has been sent at all for the flow that is provisionally invalidated, or determining if a probe packet 826 has been sent within a predetermined time period since the previous probe packet 826 was sent or since the flow was provisionally invalidated. If it is determined that the probe packet 826 has been sent for the flow, or within the predetermined time period, then the process 900 continues to block 912 and proceeds to block 716 of FIG. 7, wherein the fast path plane 604 processes the packet.

If it is determined that the probe packet 826, also referred to herein as the probe 826, was not sent since the flow was provisionally invalidated, or that probe 826 was not sent within the predetermined time period since the previous probe packet 826 was sent or since the flow was provisionally invalidated, then the process 900 proceeds to block 920, wherein a probe packet 826 is generated by the fast path plane 604 and is sent to the slow path plane 606 and in some embodiments, to the CP 806. In some embodiments, the probe packet 826 can be generated based on the received packet, and specifically can be generated based on all or portions of the received packet. In some embodiments, the probe packet 826 can comprise a replica/copy of all or portions of the received packet. In some embodiments, the probe packet 826 can comprise a replica/copy of all or portions of the header 822. In some embodiments, the probe packet 826 can be generated by decapsulating all or portions of the packet 820, and in some embodiments, the header 822. After the packet 820, and in some embodiments, the header 822 have been decapsulated, the contents of the packet 820, and in some embodiments, the header 822 can be replicated.

At block 922, the probe packet 826 is processed by the slow path 606 and, in some embodiments, by the CP 806, and the slow path 606 and, in some embodiments, the CP 806, reprograms the fast path. In some embodiments, this can include performing the steps 706 through 710 of FIG. 7 for the probe packet 826.

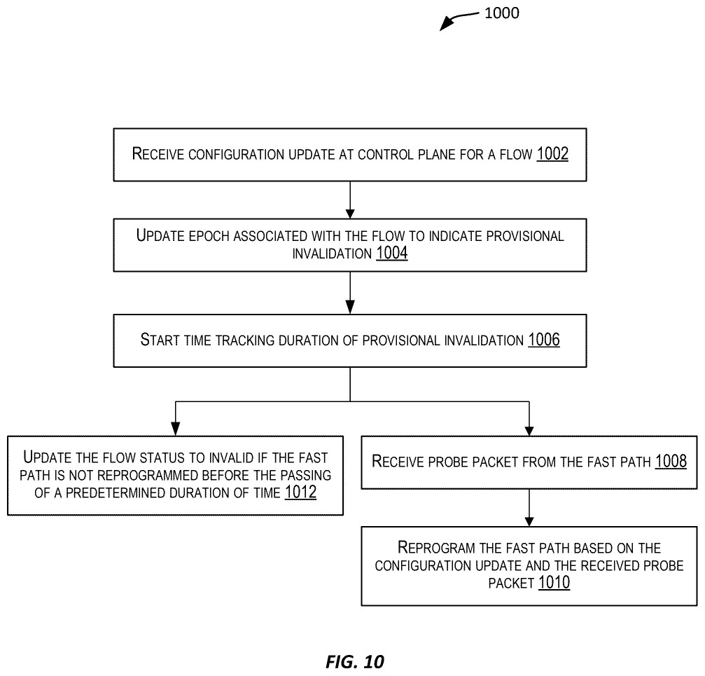

With reference now to FIG. 10, a flowchart illustrating one embodiment of a process 1000 for CP 806 actions for provisional invalidation is shown. The process 1000 can be performed by all or portions of the NVD 600, and/or by on one or several: computing systems; servers; processors, or the like. In some embodiments, the process 1000 can be performed by a plurality of NVDs and/or other processing systems, together referred to herein as a provisional invalidation system. In some embodiments, the portion(s) of the provisional invalidation system used to provide the CP 806 can perform the process 1000.

The process 1000 begins at block 1002, wherein a configuration update is received at the CP 806 for a flow. In some embodiments, the configuration update can be received from a configuration agent 808. The configuration update can include information identifying a flow impacted by the configuration update and one or several configuration changes for the configuration update.

At block 1004, a status indicator for the flow is updated to indicate that the flow associated with the configuration update is provisionally invalidated. In some embodiments, this can include updating the status indicator with the slow path plane 606 and, in some embodiments, updating the status indicator with the CP 806. Updating the status indicator can, in some embodiments, include updating an indicator associated with the previously programmed flow in the shared memory 610, and in some embodiments, can include updating an epoch associated with the previously programmed flow in the shared memory 610. In some embodiments, updating the status indicator can include providing the status indicator to the fast plane 604. Providing the status indicator can be accomplished via the shared memory 610 to include the status indicator or via sending a message to the fast plane 604, including, for example, sending an epoch bump to the fast plane 604.

At block 1006, a timer is started to track duration of the provisional invalidation. In some embodiments, the timer can be started by the slow path 606 including, for example, the CP 806, and in some embodiments, the timer can be started by the fast path 604.

In some embodiments, the steps of block 1008, 1010 can be performed alternatively to the step of block 1012 when the predetermined duration of time has not passed for the provisional invalid state. In such an embodiment, at block 1008, the slow path 606 receives the probe packet from the fast path 604. In some embodiments, this can include receiving the probe packet at the CP 806. At block 1010, the fast path 604 is reprogrammed by the slow path 606, and in some embodiments by the CP 806 based on the configuration update and the receive probe packet. In some embodiments, this reprogramming can include performing the steps 706 through 710 of FIG. 7 for the probe packet 826.

At block 1012, and alternatively to steps 1008, 1010, if the fast path is not reprogrammed before the passing of the predetermined duration of time, the status of the flow can be updated to invalid from provisionally invalid. In some embodiments, this can include the slow path 606, and in some embodiments, the CP 806 updating the shared memory 610 to include and indicator that the flow is invalid.

### Example Architectures for Providing a Cloud Service

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 11 is a block diagram 1100 illustrating an example pattern of an IaaS architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

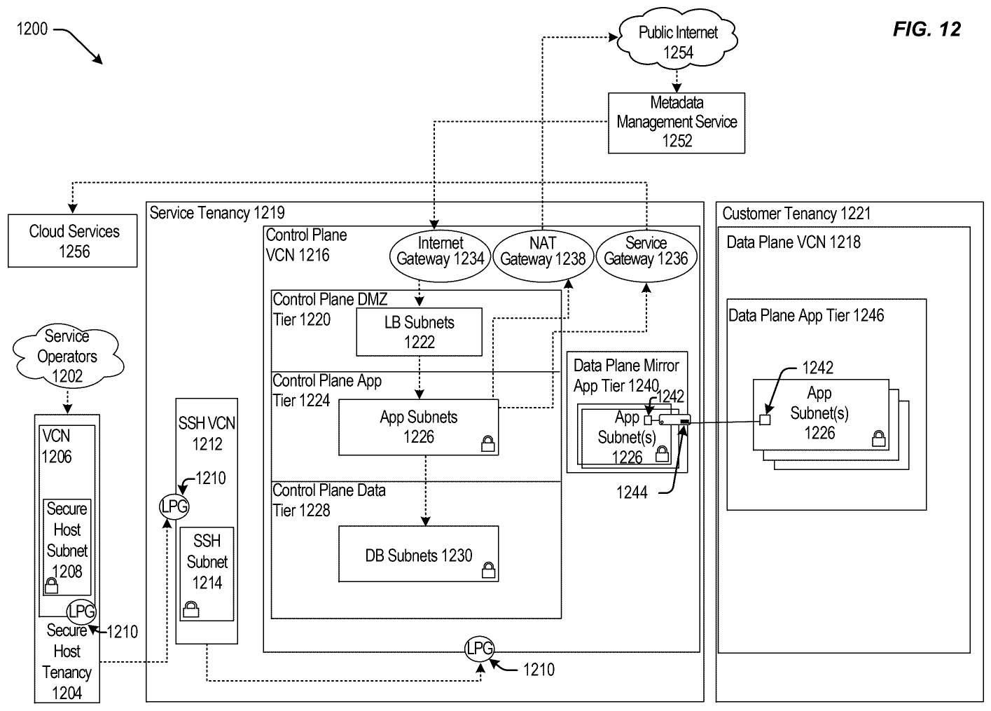

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively coupled to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with, Deployment 11 in Region 2.

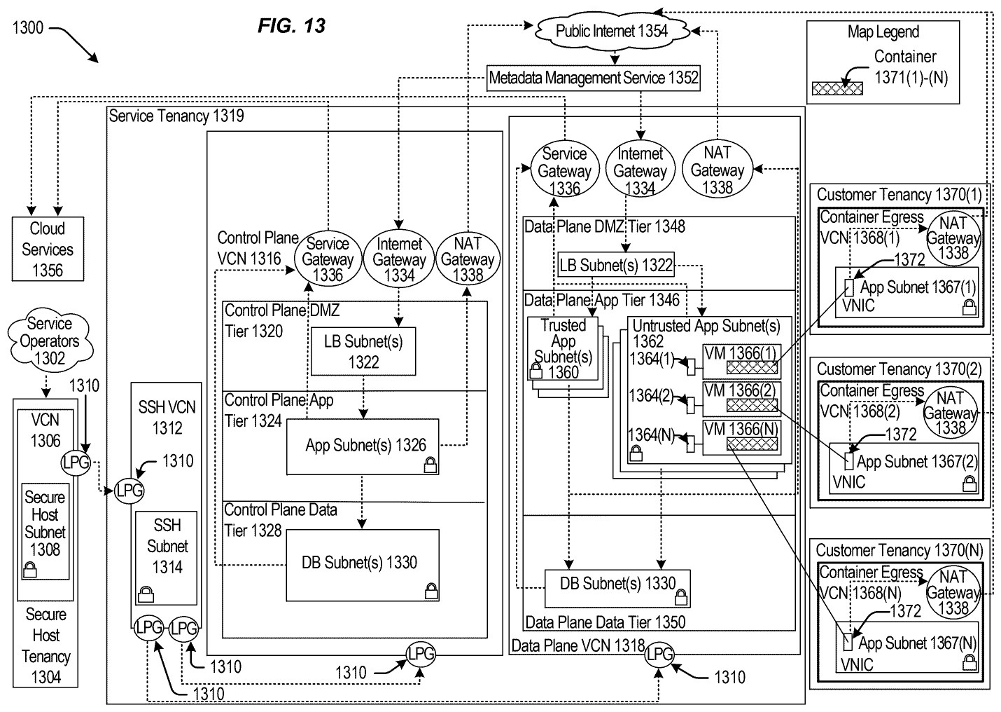

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each V 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336.

For example, a call to cloud services 1356 from the control plane VCN 1316 can include a request for a service that can communicate with the data plane VCN 1318.

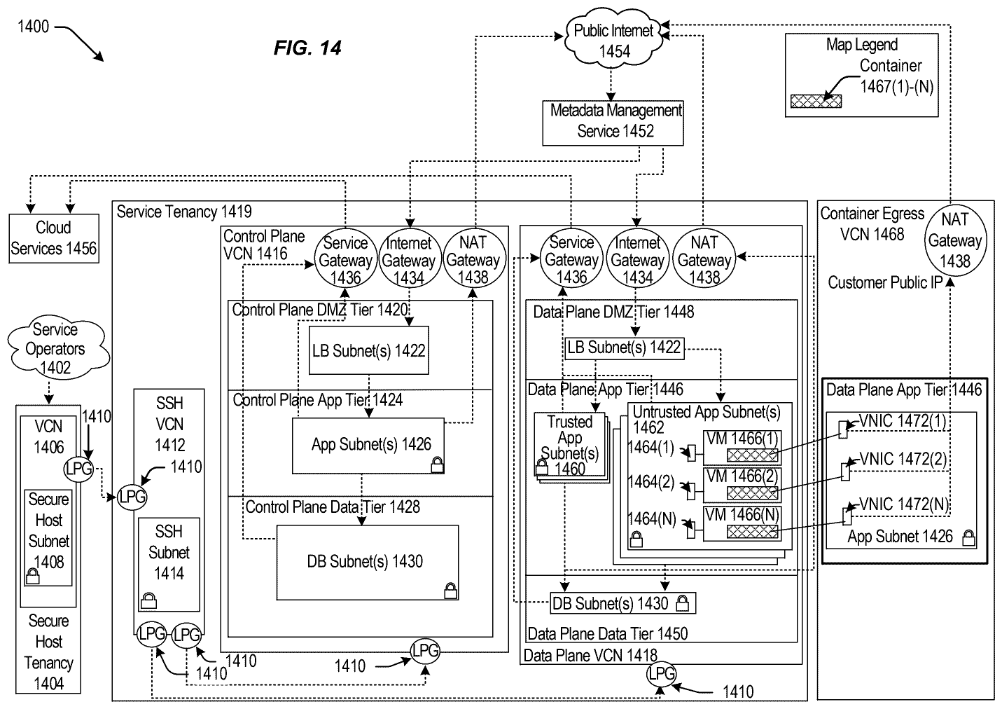

FIG. 14 is a block diagram 1400 illustrating another example pattern of an IaaS architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively coupled to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1504 provide the functionality described above. Storage subsystem 1518 may also provide a repository for storing data used in accordance with the present disclosure.

As depicted in the example in FIG. 15, storage subsystem 1518 can include various components including a system memory 1510, computer-readable storage media 1522, and a computer readable storage media reader 1520. System memory 1510 may store program instructions that are loadable and executable by processing unit 1504. System memory 1510 may also store data that is used during the execution of the instructions and/or data that is generated during the execution of the program instructions. Various different kinds of programs may be loaded into system memory 1510 including but not limited to client applications, Web browsers, mid-tier applications, relational database management systems (RDBMS), virtual machines, containers, etc.

System memory 1510 may also store an operating system 1516. Examples of operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1500 executes one or more virtual machines, the virtual machines along with their guest operating systems (GOSs) may be loaded into system memory 1510 and executed by one or more processors or cores of processing unit 1504.

System memory 1510 can come in different configurations depending upon the type of computer system 1500. For example, system memory 1510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1510 may include a basic input/output system (BIOS) containing basic routines that help to transfer information between elements within computer system 1500, such as during start-up.

Computer-readable storage media 1522 may represent remote, local, fixed, and/or removable storage devices plus storage media for temporarily and/or more permanently containing, storing, computer-readable information for use by computer system 1500 including instructions executable by processing unit 1504 of computer system 1500.

Computer-readable storage media 1522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1500.

Machine-readable instructions executable by one or more processors or cores of processing unit 1504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
receiving a packet of a flow for fast path processing according to initial fast path programming at fast path hardware of a Network Virtualization Device (“NVD”);
determining with the fast path that the flow and the initial fast path programming are provisionally invalid; and
processing the packet according to the initial fast path programming with the fast path hardware.

2. The method of claim 1, further comprising receiving a configuration update before receiving the packet.

3. The method of claim 2, wherein the configuration update is received by a control plane.

4. The method of claim 3, wherein the control plane is part of a slow path.

5. The method of claim 3, further comprising designating the initial flow as provisionally invalid with the control plane.

6. The method of claim 5, wherein designating the initial flow a provisionally invalid comprises providing an epoch bump to the fast path.

7. The method of claim 6, wherein determining with the fast path that the flow and the initial fast path programming are provisionally invalid is based on a comparison of an epoch associated with the initial fast path programming and the received epoch bump.

8. The method of claim 5, further comprising:
generating a probe packet at the fast path; and
sending the probe packet from the fast path.

9. The method of claim 8, wherein generating the probe packet comprises replicating at least portions of the received packet.

10. The method of claim 9, wherein the at least portions of the received packet comprise the header of the received packet.

11. The method of claim 8, wherein the probe packet is generated when the fast path determines that a probe packet was not previously generated for the flow of the received packet.

12. The method of claim 8, wherein the probe packet is generated when the fast path determines that a probe packet was not previously generated for the flow of the received packet within a predetermined timeframe.

13. The method of claim 8, further comprising processing the probe packet at a slow path.

14. The method of claim 13, wherein processing the probe packet at the slow path comprises reprogramming the fast path to process packets based on the configuration update.

15. The method of claim 14, wherein the programming of the fast path identifies at least one of a set of rules for: decapsulating a received packet; encapsulating a received packet; or routing a received packet.

16. The method of claim 1, wherein the flow remains provisionally invalid until the earlier of: passing of a predetermined amount of time; or reprogramming of the fast path.

17. The method of claim 1, wherein the flow is invalidated when the fast path is not reprogrammed within a predetermined amount of time.

18. The method of claim 17, further comprising:
receiving a second packet of the flow subsequent to receipt of the packet and after the passing of the predetermined amount of time;
determining with the fast path that the flow and the initial fast path programming are invalid; and
dropping the second packet.

19. A system comprising:
memory comprising processor-executable stored instructions; and
a processor configured to execute the stored instructions to:
receive a packet of a flow for fast path processing according to initial fast path programming at fast path hardware of a Network Virtualization Device (“NVD”);
determine with the fast path that the flow and the initial fast path programming are provisionally invalid; and
process the packet according to the initial fast path programming with the fast path hardware.

20. A non-transitory computer-readable storage medium storing a plurality of instructions executable by one or more processors, the plurality of instructions when executed by the one or more processors cause the one or more processors to:
receive a packet of a flow for fast path processing according to initial fast path programming at fast path hardware of a Network Virtualization Device (“NVD”);
determine with the fast path that the flow and the initial fast path programming are provisionally invalid; and
process the packet according to the initial fast path programming with the fast path hardware.
